(19) United States
(12) Patent Application Publication
(10) Pub. No.: US 2022/0295337 A1
(43) Pub. Date: Sep. 15, 2022

(54) OPERATION METHOD OF UE RELATED TO PFI IN WIRELESS COMMUNICATION SYSTEM, AND APPARATUS THEREFOR

(71) Applicant: LG ELECTRONICS INC., Seoul (KR)

(72) Inventors: Laeyoung KIM, Seoul (KR); Youngdae LEE, Seoul (KR); Myungjune YOUN, Seoul (KR)

(73) Assignee: LG ELECTRONICS INC., Seoul (KR)

(21) Appl. No.: 17/594,843

(22) PCT Filed: May 4, 2020
(86) PCT No.: PCT/KR2020/005910

§ 371 Date: Nov. 1, 2021

(30) Foreign Application Priority Data
May 3, 2019 (KR) 10-2019-0052292
May 7, 2019 (KR) 10-2019-0053279
May 10, 2019 (KR) 10-2019-0055264
May 15, 2019 (KR) 10-2019-0057094
May 29, 2019 (KR) 10-2019-0063481

(51) Int. Cl. H04W 28/02; H04W 76/14

(52) U.S. Cl. CPC H04W 28/0268; H04W 28/0263; H04W 76/14; H04W 92/18

(57) ABSTRACT

In one embodiment, an operation method of first user equipment (UE) in a wireless communication system comprises the steps in which the first UE: derives a plurality of PC5 quality of service (QoS) parameters for each of a plurality of services; and allocating a PC5 QoS flow identifier (PFI) to each of the plurality of services on the basis of the plurality of PC5 QoS parameters, wherein, even when the same PC5 QoS parameter is derived from at least two from among the plurality of services, different PFIs are respectively allocated to the at least two services.

### TECHNICAL FIELD

The present disclosure relates to a wireless communication system, and more particularly to a method and device for allowing a network data analytics function (NWDAF) to be relevant to reception of a notification message based on a change of a user plane congestion status from operations and maintenance (OAM).

### BACKGROUND ART

Wireless communication systems have been widely deployed to provide various types of communication services such as voice or data. In general, a wireless communication system is a multiple access system that supports communication of multiple users by sharing available system resources (a bandwidth, transmission power, etc.) among them. For example, multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multi-carrier frequency division multiple access (MC-FDMA) system.

Wireless communication systems adopt various radio access technologies (RATs) such as long term evolution (LTE), LTE-advanced (LTE-A), and wireless fidelity (WiFi). 5th generation (5G) is one of them. Three key requirement areas of 5G include (1) enhanced mobile broadband (eMBB), (2) massive machine type communication (mMTC), and (3) ultra-reliable and low latency communications (URLLC). Some use cases may require multiple dimensions for optimization, while others may focus only on one key performance indicator (KPI). 5G supports such diverse use cases in a flexible and reliable way.

eMBB goes far beyond basic mobile Internet access and covers rich interactive work, and media and entertainment applications in the cloud or augmented reality (AR). Data is one of the key drivers for 5G and in the 5G era, we may see no dedicated voice service for the first time. In 5G, voice is expected to be handled as an application program, simply using data connectivity provided by a communication system. The main drivers for an increased traffic volume are the increase in the size of content and the number of applications requiring high data rates. Streaming services (audio and video), interactive video, and mobile Internet connectivity will continue to be used more broadly as more devices connect to the Internet. Many of these applications require always-on connectivity to push real time information and notifications to users. Cloud storage and applications are rapidly increasing for mobile communication platforms. This is applicable for both work and entertainment. Cloud storage is one particular use case driving the growth of uplink data rates. 5G will also be used for remote work in the cloud which, when done with tactile interfaces, requires much lower end-to-end latencies in order to maintain a good user experience. Entertainment, for example, cloud gaming and video streaming, is another key driver for the increasing need for mobile broadband capacity. Entertainment will be very essential on smart phones and tablets everywhere, including high mobility environments such as trains, cars and airplanes. Another use case is augmented reality (AR) for entertainment and information search, which requires very low latencies and significant instant data volumes.

One of the most expected 5G use cases is the functionality of actively connecting embedded sensors in every field, that is, mMTC. It is expected that there will be 20.4 billion potential Internet of things (IoT) devices by 2020. In industrial IoT, 5G is one of areas that play key roles in enabling smart city, asset tracking, smart utility, agriculture, and security infrastructure.

URLLC includes services which will transform industries with ultra-reliable/available, low latency links such as remote control of critical infrastructure and self-driving vehicles. The level of reliability and latency are vital to smart-grid control, industrial automation, robotics, drone control and coordination, and so on.

Now, multiple use cases will be described in greater detail.

5G may complement fiber-to-the home (FTTH) and cable-based broadband (or data-over-cable service interface specifications (DOCSIS)) as a means of providing streams at data rates of hundreds of megabits per second to giga bits per second. Such a high speed is required for TV broadcasts at or above a resolution of 4K (6K, 8K, and higher) as well as virtual reality (VR) and AR. VR and AR applications mostly include immersive sport games. A special network configuration may be required for a specific application program. For VR games, for example, game companies may have to integrate a core server with an edge network server of a network operator in order to minimize latency.

The automotive sector is expected to be a very important new driver for 5G, with many use cases for mobile communications for vehicles. For example, entertainment for passengers requires simultaneous high capacity and high mobility mobile broadband, because future users will expect to continue their good quality connection independent of their location and speed. Other use cases for the automotive sector are AR dashboards. These display overlay information on top of what a driver is seeing through the front window, identifying objects in the dark and telling the driver about the distances and movements of the objects. In the future, wireless modules will enable communication between vehicles themselves, information exchange between vehicles and supporting infrastructure and between vehicles and other connected devices (e.g., those carried by pedestrians). Safety systems may guide drivers on alternative courses of action to allow them to drive more safely and lower the risks of accidents. The next stage will be remote-controlled or self-driving vehicles. These require very reliable, very fast communication between different self-driving vehicles and between vehicles and infrastructure. In the future, self-driving vehicles will execute all driving activities, while drivers are focusing on traffic abnormality elusive to the vehicles themselves. The technical requirements for self-driving vehicles call for ultra-low latencies and ultra-high reliability, increasing traffic safety to levels humans cannot achieve.

Smart cities and smart homes, often referred to as smart society, will be embedded with dense wireless sensor networks. Distributed networks of intelligent sensors will identify conditions for cost- and energy-efficient maintenance of the city or home. A similar setup can be done for each home, where temperature sensors, window and heating controllers, burglar alarms, and home appliances are all connected wirelessly. Many of these sensors are typically characterized by low data rate, low power, and low cost, but for example, real time high definition (HD) video may be required in some types of devices for surveillance.

The consumption and distribution of energy, including heat or gas, is becoming highly decentralized, creating the need for automated control of a very distributed sensor network. A smart grid interconnects such sensors, using digital information and communications technology to gather and act on information. This information may include information about the behaviors of suppliers and consumers, allowing the smart grid to improve the efficiency, reliability, economics and sustainability of the production and distribution of fuels such as electricity in an automated fashion. A smart grid may be seen as another sensor network with low delays.

The health sector has many applications that may benefit from mobile communications. Communications systems enable telemedicine, which provides clinical health care at a distance. It helps eliminate distance barriers and may improve access to medical services that would often not be consistently available in distant rural communities. It is also used to save lives in critical care and emergency situations. Wireless sensor networks based on mobile communication may provide remote monitoring and sensors for parameters such as heart rate and blood pressure.

Wireless and mobile communications are becoming increasingly important for industrial applications. Wires are expensive to install and maintain, and the possibility of replacing cables with reconfigurable wireless links is a tempting opportunity for many industries. However, achieving this requires that the wireless connection works with a similar delay, reliability and capacity as cables and that its management is simplified. Low delays and very low error probabilities are new requirements that need to be addressed with 5G.

Finally, logistics and freight tracking are important use cases for mobile communications that enable the tracking of inventory and packages wherever they are by using location-based information systems. The logistics and freight tracking use cases typically require lower data rates but need wide coverage and reliable location information.

### DISCLOSURE

Technical Task

A method relating to assigning a PFI per service based on a QoS parameter is disclosed in an embodiment.

Technical tasks obtainable from the present disclosure are non-limited by the above-mentioned technical task. And, other unmentioned technical tasks can be clearly understood from the following description by those having ordinary skill in the technical field to which the present disclosure pertains.

### Technical Solutions

In one technical aspect of the present disclosure, provided is a method of operating a first User Equipment (UE) in a wireless communication system, the method including deriving a plurality of PC5 QoS (Quality of Service) parameters for a plurality of services by the first UE, respectively and assigning PFIs (PC5 QoS Flow Identifiers) to a plurality of the services by the first UE based on a plurality of the PC5 QoS parameters, respectively, wherein although the same PC5 QoS parameter may be derived from two or more of a plurality of the services, different PFIs are assigned to the two or more services, respectively.

In another technical aspect of the present disclosure, provided is an apparatus in a wireless communication system, the apparatus including at least one processor and at least one computer memory operatively connected to the at least one processor and storing instructions enabling the at least one processor to perform operations when executed, the operations including deriving a plurality of PC5 QoS (Quality of Service) parameters for a plurality of services by the first UE, respectively and assigning PFIs (PC5 QoS Flow Identifiers) to a plurality of the services by the first UE based on a plurality of the PC5 QoS parameters, respectively, wherein although the same PC5 QoS parameter may be derived from two or more of a plurality of the services, different PFIs are assigned to the two or more services, respectively.

A plurality of the services may be related to one PC5 unicast link between the first UE and a second UE.

The PFI, the PC5 QoS parameter related to the PFI and service information may be delivered to the second UE via a PC5-S message.

The first UE may correspond to a UE starting PC5 unicast link establishment or a UE initiating established PC5 unicast link modification.

Each of a plurality of the PC5 QoS parameters may be derived by a V2X layer using PC5 QoS requirements provided by an application layer as an input.

Each of a plurality of the PC5 QoS parameters may be related to a default value for the PC5 QoS parameter based on that PC5 QoS related information is not provided by an application layer.

A plurality of the services may be identified by Provider Service Identifier (PSID) or ITS Application Identifier (ITS-AID).

### Advantageous Effects

According to the present disclosure, a plurality of services related to a single PC5 link may be identified.

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings.

### DESCRIPTION OF DRAWINGS

The accompanying drawings, which are included to provide a further understanding of the disclosure, illustrate embodiments of the disclosure and together with the description serve to explain the principle of the disclosure. In the drawings:

FIG. 1 is a schematic diagram illustrating the structure of an evolved packet system (EPS) including an evolved packet core (EPC).

FIG. 2 is a diagram illustrating the general architectures of an E-UTRAN and an EPC.

FIG. 3 is a diagram illustrating the structure of a radio interface protocol in a control plane.

FIG. 4 is a diagram illustrating the structure of a radio interface protocol in a user plane.

FIG. 5 is a flowchart illustrating a random access procedure.

FIG. 6 is a diagram illustrating a connection process in a radio resource control (RRC) layer.

FIG. 7 is a diagram illustrating a 5th generation (5G) system.

FIGS. 8 to 27 are diagrams to describe embodiment(s) of the present disclosure.

FIG. 28 illustrates a communication system 1 applied to the present disclosure.

FIG. 29 illustrates a wireless device applicable to the present disclosure.

FIG. 30 illustrates a signal processing circuit for a Tx signal.

FIG. 31 illustrates another example of a wireless device applied to the present disclosure.

FIG. 32 illustrates a portable device applied to the present disclosure.

FIG. 33 illustrates a vehicle or an autonomous vehicle applied to the present disclosure.

FIG. 34 illustrates a vehicle applied to the present disclosure.

FIG. 35 illustrates an XR device applied to the present disclosure.

FIG. 36 illustrates a robot applied to the present disclosure.

FIG. 37 illustrates an AI device applied to the present disclosure.

### BEST MODE FOR DISCLOSURE

The embodiments below are combinations of components and features of the present disclosure in a prescribed form. Each component or feature may be considered as selective unless explicitly mentioned as otherwise. Each component or feature may be executed in a form that is not combined with other components and features. Further, some components and/or features may be combined to configure an embodiment of the present disclosure. The order of operations described in the embodiments of the present disclosure may be changed. Some components or features of an embodiment may be included in another embodiment or may be substituted with a corresponding component or feature of the present disclosure.

Specific terms used in the description below are provided to help an understanding of the present disclosure, and the use of such specific terms may be changed to another form within the scope of the technical concept of the present disclosure.

In some cases, in order to avoid obscurity of the concept of the present disclosure, a known structure and apparatus may be omitted, or a block diagram centering on core functions of each structure or apparatus may be used. Moreover, the same reference numerals are used for the same components throughout the present specification.

The embodiments of the present disclosure may be supported by standard documents disclosed with respect to at least one of IEEE (Institute of Electrical and Electronics Engineers) 802 group system, 3GPP system, 3GPP LTE & LTE-A system and 3GPP2 system. Namely, the steps or portions having not been described in order to clarify the technical concept of the present disclosure in the embodiments of the present disclosure may be supported by the above documents. Furthermore, all terms disclosed in the present document may be described according to the above standard documents.

The technology below may be used for various wireless communication systems. For clarity, the description below centers on 3GPP LTE and 3GPP LTE-A, by which the technical idea of the present disclosure is non-limited.

Terms used in the present document are defined as follows.
UMTS (Universal Mobile Telecommunications System): a GSM (Global System for Mobile Communication) based third generation mobile communication technology developed by the 3GPP.
EPS (Evolved Packet System): a network system that includes an EPC (Evolved Packet Core) which is an IP (Internet Protocol) based packet switched core network and an access network such as LTE and UTRAN. This system is the network of an evolved version of the UMTS.
NodeB: a base station of GERAN/UTRAN. This base station is installed outdoor and its coverage has a scale of a macro cell.
eNodeB: a base station of LTE. This base station is installed outdoor and its coverage has a scale of a macro cell.
UE (User Equipment): the UE may be referred to as terminal, ME (Mobile Equipment), MS (Mobile Station), etc. Also, the UE may be a portable device such as a notebook computer, a cellular phone, a PDA (Personal Digital Assistant), a smart phone, and a multimedia device. Alternatively, the UE may be a non-portable device such as a PC (Personal Computer) and a vehicle mounted device. The term “UE”, as used in relation to MTC, can refer to an MTC device.
HNB (Home NodeB): a base station of UMTS network. This base station is installed indoor and its coverage has a scale of a micro cell.
HeNB (Home eNodeB): a base station of an EPS network. This base station is installed indoor and its coverage has a scale of a micro cell.
MME (Mobility Management Entity): a network node of an EPS network, which performs mobility management (MM) and session management (SM).
PDN-GW (Packet Data Network-Gateway)/PGW: a network node of an EPS network, which performs UE IP address allocation, packet screening and filtering, charging data collection, etc.
SGW (Serving Gateway): a network node of an EPS network, which performs mobility anchor, packet routing, idle-mode packet buffering, and triggering of an MME's UE paging.
NAS (Non-Access Stratum): an upper stratum of a control plane between a UE and an MME. This is a functional layer for transmitting and receiving a signaling and traffic message between a UE and a core network in an LTE/UMTS protocol stack, and supports mobility of a UE, and supports a session management procedure of establishing and maintaining IP connection between a UE and a PDN GW.
PDN (Packet Data Network): a network in which a server supporting a specific service (e.g., a Multimedia Messaging Service (MMS) server, a Wireless Application Protocol (WAP) server, etc.) is located.
PDN connection: a logical connection between a UE and a PDN, represented as one IP address (one IPv4 address and/or one IPv6 prefix).
RAN (Radio Access Network): a unit including a Node B, an eNode B, and a Radio Network Controller (RNC) for controlling the Node B and the eNode B in a 3GPP network, which is present between UEs and provides a connection to a core network.
HLR (Home Location Register)/HSS (Home Subscriber Server): a database having subscriber information in a 3GPP network. The HSS can perform functions such as configuration storage, identity management, and user state storage.
PLMN (Public Land Mobile Network): a network configured for the purpose of providing mobile communication services to individuals. This network can be configured per operator.
Proximity Services (or ProSe Service or Proximity-based Service): a service that enables discovery between physically proximate devices, and mutual direct communication/communication through a base station/communication through the third party. At this time, user plane data is exchanged through a direct data path without passing through a 3GPP core network (e.g., EPC).

EPC (Evolved Packet Core)

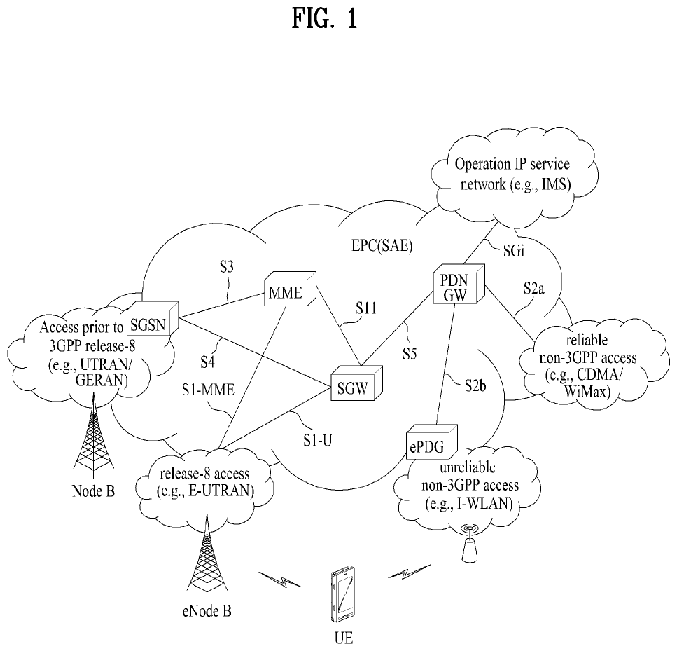

FIG. 1 is a schematic diagram showing the structure of an evolved packet system (EPS) including an evolved packet core (EPC).

The EPC is a core element of system architecture evolution (SAE) for improving performance of 3GPP technology. SAE corresponds to a research project for determining a network structure supporting mobility between various types of networks. For example, SAE aims to provide an optimized packet-based system for supporting various radio access technologies and providing an enhanced data transmission capability.

Specifically, the EPC is a core network of an IP mobile communication system for 3GPP LTE and can support real-time and non-real-time packet-based services. In conventional mobile communication systems (i.e. second-generation or third-generation mobile communication systems), functions of a core network are implemented through a circuit-switched (CS) sub-domain for voice and a packet-switched (PS) sub-domain for data. However, in a 3GPP LTE system which is evolved from the third generation communication system, CS and PS sub-domains are unified into one IP domain. That is, In 3GPP LTE, connection of terminals having IP capability can be established through an IP-based business station (e.g., an eNodeB (evolved Node B)), EPC, and an application domain (e.g., IMS). That is, the EPC is an essential structure for end-to-end IP services.

The EPC may include various components. FIG. 1 shows some of the components, namely, a serving gateway (SGW), a packet data network gateway (PDN GW), a mobility management entity (MME), a serving GPRS (general packet radio service) supporting node (SGSN) and an enhanced packet data gateway (ePDG).

SGW (or S-GW) operates as a boundary point between a radio access network (RAN) and a core network and maintains a data path between an eNodeB and the PDN GW. When. When a terminal moves over an area served by an eNodeB, the SGW functions as a local mobility anchor point. That is, packets. That is, packets may be routed through the SGW for mobility in an evolved UMTS terrestrial radio access network (E-UTRAN) defined after 3GPP release-8. In addition, the SGW may serve as an anchor point for mobility of another 3GPP network (a RAN defined before 3GPP release-8, e.g., UTRAN or GERAN (global system for mobile communication (GSM)/enhanced data rates for global evolution (EDGE) radio access network).

The PDN GW (or P-GW) corresponds to a termination point of a data interface for a packet data network. The PDN GW may support policy enforcement features, packet filtering and charging support. In addition, the PDN GW may serve as an anchor point for mobility management with a 3GPP network and a non-3GPP network (e.g., an unreliable network such as an interworking wireless local area network (I-WLAN) and a reliable network such as a code division multiple access (CDMA) or WiMax network).

Although the SGW and the PDN GW are configured as separate gateways in the example of the network structure of FIG. 1, the two gateways may be implemented according to a single gateway configuration option.

The MME performs signaling and control functions for supporting access of a UE for network connection, network resource allocation, tracking, paging, roaming and handover. The MME controls control plane functions associated with subscriber and session management. The MME manages numerous eNodeBs and signaling for selection of a conventional gateway for handover to other 2G/3G networks. In addition, the MME performs security procedures, terminal-to-network session handling, idle terminal location management, etc.

The SGSN handles all packet data such as mobility management and authentication of a user for other 3GPP networks (e.g., a GPRS network).

The ePDG serves as a security node for a non-3GPP network (e.g., an I-WLAN, a Wi-Fi hotspot, etc.).

As described above with reference to FIG. 1, a terminal having IP capabilities may access an IP service network (e.g., an IMS) provided by an operator via various elements in the EPC not only based on 3GPP access but also based on non-3GPP access.

Additionally, FIG. 1 shows various reference points (e.g. S1-U, S1-MME, etc.). In 3GPP, a conceptual link connecting two functions of different functional entities of an E-UTRAN and an EPC is defined as a reference point. Table 1 is a list of the reference points shown in FIG. 1. Various reference points may be present in addition to the reference points in Table 1 according to network structures.

TABLE 1

| Reference | |
|---|---|
| point | Description |
| S1-MME | Reference point for the control plane protocol between E-UTRAN and MME |
| S1-U | Reference point between E-UTRAN and Serving GW for the per bearer user plane |
| | tunneling and inter eNodeB path switching during handover |
| S3 | It enables user and bearer information exchange for inter 3GPP access network |
| | mobility in idle and/or active state. This reference point can be used intra-PLMN or |
| | inter-PLMN (e.g. in the case of Inter-PLMN HO). |
| S4 | It provides related control and mobility support between GPRS Core and the 3GPP |
| | Anchor function of Serving GW. In addition, if Direct Tunnel is not established, it |
| | provides the user plane tunneling. |
| S5 | It provides user plane tunneling and tunnel management between Serving GW and |
| | PDN GW. It is used for Serving GW relocation due to UE mobility and if the Serving |
| | GW needs to connect to a non-collocated PDN GW for the required PDN |
| | connectivity. |
| S11 | Reference point between an MME and an SGW |
| SGi | It is the reference point between the PDN GW and the packet data network. Packet |
| | data network may be an operator external public or private packet data network or an |
| | intra operator packet data network, e.g. for provision of IMS services. This reference |
| | point corresponds to Gi for 3GPP accesses. |

Among the reference points shown in FIG. 1, S2a and S2b correspond to non-3GPP interfaces. S2a is a reference point which provides reliable non-3GPP access and related control and mobility support between PDN GWs to a user plane. S2b is a reference point which provides related control and mobility support between the ePDG and the PDN GW to the user plane.

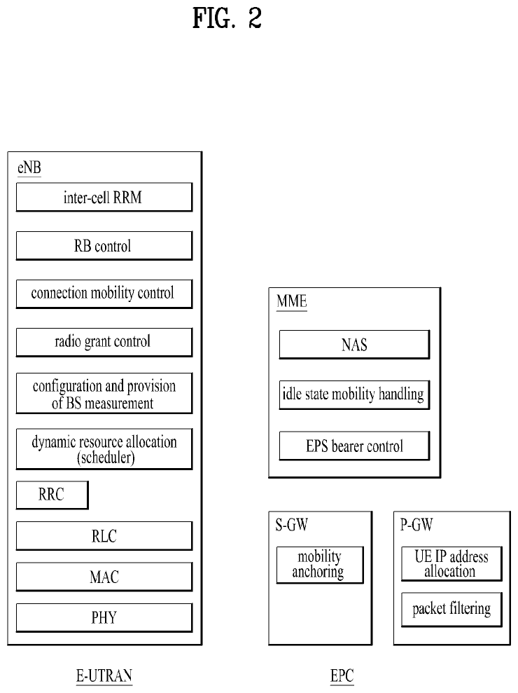

FIG. 2 is a diagram exemplarily illustrating architectures of a typical E-UTRAN and EPC.

As shown in the figure, while radio resource control (RRC) connection is activated, an eNodeB may perform routing to a gateway, scheduling transmission of a paging message, scheduling and transmission of a broadcast channel (BCH), dynamic allocation of resources to a UE on uplink and downlink, configuration and provision of eNodeB measurement, radio bearer control, radio admission control, and connection mobility control. In the EPC, paging generation, LTE IDLE state management, ciphering of the user plane, SAE bearer control, and ciphering and integrity protection of NAS signaling.

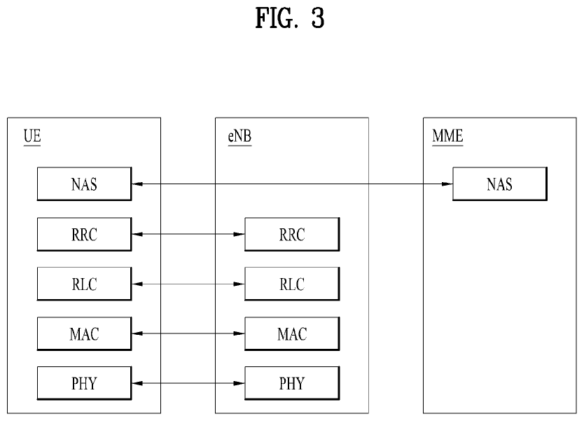

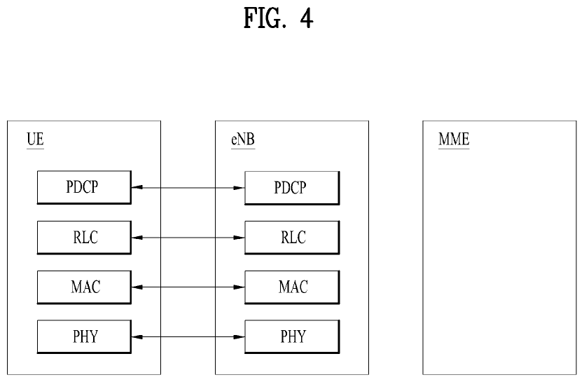

FIG. 3 is a diagram exemplarily illustrating the structure of a radio interface protocol in a control plane between a UE and a base station, and FIG. 4 is a diagram exemplarily illustrating the structure of a radio interface protocol in a user plane between the UE and the base station.

The radio interface protocol is based on the 3GPP wireless access network standard. The radio interface protocol horizontally includes a physical layer, a data link layer, and a networking layer. The radio interface protocol is divided into a user plane for transmission of data information and a control plane for delivering control signaling which are arranged vertically.

The protocol layers may be classified into a first layer (L1), a second layer (L2), and a third layer (L3) based on the three sublayers of the open system interconnection (OSI) model that is well known in the communication system.

Hereinafter, description will be given of a radio protocol in the control plane shown in FIG. 3 and a radio protocol in the user plane shown in FIG. 4.

The physical layer, which is the first layer, provides an information transfer service using a physical channel. The physical channel layer is connected to a medium access control (MAC) layer, which is a higher layer of the physical layer, through a transport channel. Data is transferred between the physical layer and the MAC layer through the transport channel. Transfer of data between different physical layers, i.e., a physical layer of a transmitter and a physical layer of a receiver is performed through the physical channel.

The physical channel consists of a plurality of subframes in the time domain and a plurality of subcarriers in the frequency domain. One subframe consists of a plurality of symbols in the time domain and a plurality of subcarriers. One subframe consists of a plurality of resource blocks. One resource block consists of a plurality of symbols and a plurality of subcarriers. A Transmission Time Interval (TTI), a unit time for data transmission, is 1 ms, which corresponds to one subframe.

According to 3GPP LTE, the physical channels present in the physical layers of the transmitter and the receiver may be divided into data channels corresponding to Physical Downlink Shared Channel (PDSCH) and Physical Uplink Shared Channel (PUSCH) and control channels corresponding to Physical Downlink Control Channel (PDCCH), Physical Control Format Indicator Channel (PCFICH), Physical Hybrid-ARQ Indicator Channel (PHICH) and Physical Uplink Control Channel (PUCCH).

The second layer includes various layers.

First, the MAC layer in the second layer serves to map various logical channels to various transport channels and also serves to map various logical channels to one transport channel. The MAC layer is connected with an RLC layer, which is a higher layer, through a logical channel. The logical channel is broadly divided into a control channel for transmission of information of the control plane and a traffic channel for transmission of information of the user plane according to the types of transmitted information.

The radio link control (RLC) layer in the second layer serves to segment and concatenate data received from a higher layer to adjust the size of data such that the size is suitable for a lower layer to transmit the data in a radio interval.

The Packet Data Convergence Protocol (PDCP) layer in the second layer performs a header compression function of reducing the size of an IP packet header which has a relatively large size and contains unnecessary control information, in order to efficiently transmit an IP packet such as an IPv4 or IPv6 packet in a radio interval having a narrow bandwidth. In addition, in LTE, the PDCP layer also performs a security function, which consists of ciphering for preventing a third party from monitoring data and integrity protection for preventing data manipulation by a third party.

The Radio Resource Control (RRC) layer, which is located at the uppermost part of the third layer, is defined only in the control plane, and serves to configure radio bearers (RBs) and control a logical channel, a transport channel, and a physical channel in relation to reconfiguration and release operations. The RB represents a service provided by the second layer to ensure data transfer between a UE and the E-UTRAN.

If an RRC connection is established between the RRC layer of the UE and the RRC layer of a wireless network, the UE is in the RRC Connected mode. Otherwise, the UE is in the RRC Idle mode.

Hereinafter, description will be given of the RRC state of the UE and an RRC connection method. The RRC state refers to a state in which the RRC of the UE is or is not logically connected with the RRC of the E-UTRAN. The RRC state of the UE having logical connection with the RRC of the E-UTRAN is referred to as an RRC_CONNECTED state. The RRC state of the UE which does not have logical connection with the RRC of the E-UTRAN is referred to as an RRC_IDLE state. A UE in the RRC_CONNECTED state has RRC connection, and thus the E-UTRAN may recognize presence of the UE in a cell unit. Accordingly, the UE may be efficiently controlled. On the other hand, the E-UTRAN cannot recognize presence of a UE which is in the RRC_IDLE state. The UE in the RRC_IDLE state is managed by a core network in a tracking area (TA) which is an area unit larger than the cell. That is, for the UE in the RRC_IDLE state, only presence or absence of the UE is recognized in an area unit larger than the cell. In order for the UE in the RRC_IDLE state to be provided with a usual mobile communication service such as a voice service and a data service, the UE should transition to the RRC_CONNECTED state. A TA is distinguished from another TA by a tracking area identity (TAI) thereof. A UE may configure the TAI through a tracking area code (TAC), which is information broadcast from a cell.

When the user initially turns on the UE, the UE searches for a proper cell first. Then, the UE establishes RRC connection in the cell and registers information thereabout in the core network. Thereafter, the UE stays in the RRC_IDLE state. When necessary, the UE staying in the RRC_IDLE state selects a cell (again) and checks system information or paging information. This operation is called camping on a cell. Only when the UE staying in the RRC_IDLE state needs to establish RRC connection, does the UE establish RRC connection with the RRC layer of the E-UTRAN through the RRC connection procedure and transition to the RRC_CONNECTED state. The UE staying in the RRC_IDLE state needs to establish RRC connection in many cases. For example, the cases may include an attempt of a user to make a phone call, an attempt to transmit data, or transmission of a response message after reception of a paging message from the E-UTRAN.

The non-access stratum (NAS) layer positioned over the RRC layer performs functions such as session management and mobility management.

Hereinafter, the NAS layer shown in FIG. 3 will be described in detail.

The eSM (evolved Session Management) belonging to the NAS layer performs functions such as default bearer management and dedicated bearer management to control a UE to use a PS service from a network. The UE is assigned a default bearer resource by a specific packet data network (PDN) when the UE initially accesses the PDN. In this case, the network allocates an available IP to the UE to allow the UE to use a data service. The network also allocates QoS of a default bearer to the UE. LTE supports two kinds of bearers. One bearer is a bearer having characteristics of guaranteed bit rate (GBR) QoS for guaranteeing a specific bandwidth for transmission and reception of data, and the other bearer is a non-GBR bearer which has characteristics of best effort QoS without guaranteeing a bandwidth. The default bearer is assigned to a non-GBR bearer. The dedicated bearer may be assigned a bearer having QoS characteristics of GBR or non-GBR.

A bearer allocated to the UE by the network is referred to as an evolved packet service (EPS) bearer. When the EPS bearer is allocated to the UE, the network assigns one identifier (ID). This ID is called an EPS bearer ID. One EPS bearer has QoS characteristics of a maximum bit rate (MBR) and/or a guaranteed bit rate (GBR).

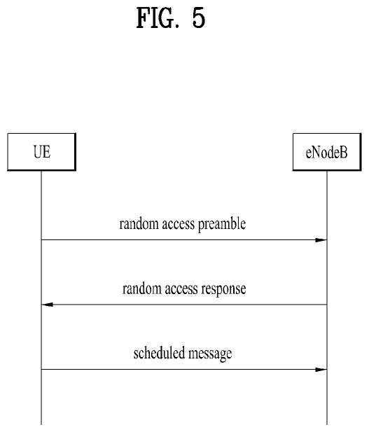

FIG. 5 is a flowchart illustrating a random access procedure in 3GPP LTE.

The random access procedure is used for a UE to obtain UL synchronization with an eNB or to be assigned a UL radio resource.

The UE receives a root index and a physical random access channel (PRACH) configuration index from an eNodeB. Each cell has 64 candidate random access preambles defined by a Zadoff-Chu (ZC) sequence. The root index is a logical index used for the UE to generate 64 candidate random access preambles.

Transmission of a random access preamble is limited to a specific time and frequency resources for each cell. The PRACH configuration index indicates a specific subframe and preamble format in which transmission of the random access preamble is possible.

The UE transmits a randomly selected random access preamble to the eNodeB. The UE selects a random access preamble from among 64 candidate random access preambles and the UE selects a subframe corresponding to the PRACH configuration index. The UE transmits the selected random access preamble in the selected subframe.

Upon receiving the random access preamble, the eNodeB sends a random access response (RAR) to the UE. The RAR is detected in two steps. First, the UE detects a PDCCH masked with a random access (RA)-RNTI. The UE receives an RAR in a MAC (medium access control) PDU (protocol data unit) on a PDSCH indicated by the detected PDCCH.

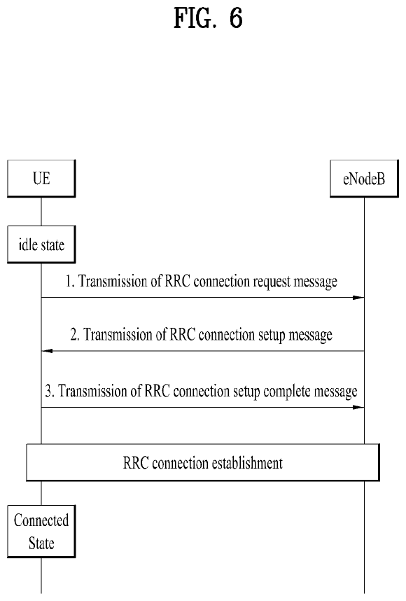

FIG. 6 illustrates a connection procedure in a radio resource control (RRC) layer.

As shown in FIG. 6, the RRC state is configured according to whether or not RRC connection is established. An RRC state indicates whether or not an entity of the RRC layer of a UE has logical connection with an entity of the RRC layer of an eNodeB. An RRC state in which the entity of the RRC layer of the UE is logically connected with the entity of the RRC layer of the eNodeB is called an RRC connected state. An RRC state in which the entity of the RRC layer of the UE is not logically connected with the entity of the RRC layer of the eNodeB is called an RRC idle state.

A UE in the Connected state has RRC connection, and thus the E-UTRAN may recognize presence of the UE in a cell unit. Accordingly, the UE may be efficiently controlled. On the other hand, the E-UTRAN cannot recognize presence of a UE which is in the idle state. The UE in the idle state is managed by the core network in a tracking area unit which is an area unit larger than the cell. The tracking area is a unit of a set of cells. That is, for the UE which is in the idle state, only presence or absence of the UE is recognized in a larger area unit. In order for the UE in the idle state to be provided with a usual mobile communication service such as a voice service and a data service, the UE should transition to the connected state.

When the user initially turns on the UE, the UE searches for a proper cell first, and then stays in the idle state. Only when the UE staying in the idle state needs to establish RRC connection, the UE establishes RRC connection with the RRC layer of the eNodeB through the RRC connection procedure and then performs transition to the RRC connected state.

The UE staying in the idle state needs to establish RRC connection in many cases. For example, the cases may include an attempt of a user to make a phone call, an attempt to transmit data, or transmission of a response message after reception of a paging message from the E-UTRAN.

In order for the UE in the idle state to establish RRC connection with the eNodeB, the RRC connection procedure needs to be performed as described above. The RRC connection procedure is broadly divided into transmission of an RRC connection request message from the UE to the eNodeB, transmission of an RRC connection setup message from the eNodeB to the UE, and transmission of an RRC connection setup complete message from the UE to eNodeB, which are described in detail below with reference to FIG. 6.

1) When the UE in the idle state desires to establish RRC connection for reasons such as an attempt to make a call, a data transmission attempt, or a response of the eNodeB to paging, the UE transmits an RRC connection request message to the eNodeB first.

2) Upon receiving the RRC connection request message from the UE, the ENB accepts the RRC connection request of the UE when the radio resources are sufficient, and then transmits an RRC connection setup message, which is a response message, to the UE.

3) Upon receiving the RRC connection setup message, the UE transmits an RRC connection setup complete message to the eNodeB. Only when the UE successfully transmits the RRC connection setup message, does the UE establish RRC connection with the eNode B and transition to the RRC connected mode.

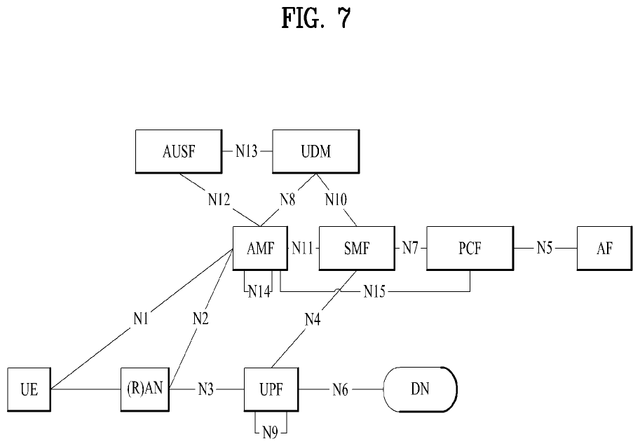

The functionality of the MME in the legacy EPC is decomposed into the access and mobility management function (AMF) and the session management function (SMF) in the next generation system (or 5G core network (CN)). The AMF carries out NAS interaction with a UE and mobility management (MM), whereas the SMF carries out session management (SM). The SMF also manages a gateway, user plane function (UPF), which has the user-plane functionality, that is, routes user traffic. It may be considered that the SMF and the UPF implement the control-plane part and user-plane part of the S-GW and the P-GW of the legacy EPC, respectively. To route user traffic, one or more UPFs may exist between a RAN and a data network (DN). That is, for 5G implementation, the legacy EPC may have the configuration illustrated in FIG. 7. In the 5G system, a protocol data unit (PDU) session has been defined as a counterpart to a PDN connection of the legacy EPS. A PDU session refers to association between a UE and a DN, which provides a PDU connectivity service of an Ethernet type or an unstructured type as well as an IP type. The unified data management (UDM) performs the same functionality as the HSS of the EPC, and the policy control function (PCF) performs the same functionality as the policy and charging rules function (PCRF) of the EPC. Obviously, the functionalities may be extended to satisfy the requirements of the 5G system. For details of the architecture, functions, and interfaces of a 5G system, TS 23.501 is conformed to.

The 5G system is being worked on in TS 23.501 and TS 23.502. Accordingly, the technical specifications are conformed to for the 5G system in the present disclosure. Further, TS 38.300 is conformed to for details of NG-RAN-related architecture and contents. As the 5G system also supports non-3GPP access, section 4.2.8 of TS 23.501 describes architecture and network elements for supporting non-3GPP access, and section 4.12 of TS 23.502 describes procedures for supporting non-3GPP access. A representative example of non-3GPP access is WLAN access, which may include both a trusted WLAN and an untrusted WLAN. The AMF of the 5G system performs registration management (RM) and connection management (CM) for non-3GPP access as well as 3GPP access. As such, the same AMF serves a UE for 3GPP access and non-3GPP access belonging to the same PLMN, so that one network function may integrally and efficiently support authentication, mobility management, and session management for UEs registered through two different accesses.

In case of LTE based PC5, QoS processing is performed based on ProSe Per-Packet Priority (PPPP) and ProSe Per-Packet Reliability (PPPR), and refers to TS 23.285 for details.

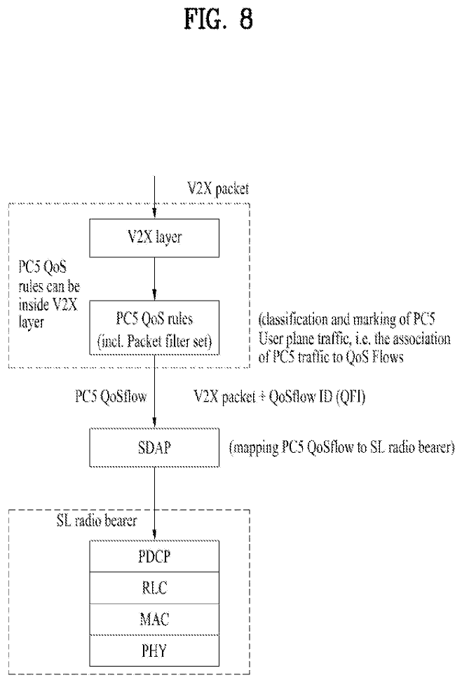

In case of NR based PC5, a QoS model similar to the definition in TS 23.501 with respect to a Uu reference point (e.g., 5QI based). In case of V2X communication over an NR based PC5 reference point, a QoS flow is associated with a PC5 QoS profile including a QoS parameter defined in Section TS 23.287 v0.3.0 5.4.2. A standardized PC5 5Qi (PQI) set is defined in Section TS 23.287 v0.3.0 5.4.4. In order for a UE to use it for a V2X service, as defined in Section TS 23.287 v0.3.0 5.1.2.1, a default PC5 QoS profile set may be configured. To NR based unicast, group case and broadcast PC5 communication, a per-flow QoS model for PC5 QoS management should apply. FIG. 8 shows a mapping example of a per-flow QiS model for NR PC5.

The following rules apply when C2X communication is forwarded over a PC5 reference point.

An application layer may configure QoS requirements for V2X communication using PPPP and PPPR models or PQI and range models defined in TS 23.285. Depending on a type of a PC5 reference point selected for transmission, i.e., an LTE or NR base, a UE may map the application layer provided QoS requirements to appropriate QoS parameters to deliver to a lower layer. The mapping between two QoS models is defined in Section TS 23.287v0.3.0 5.4.2.

In case of using a groupcast or unicast mode of V2X communication over NR based PC5, a range parameter is associated with a QoS parameter of V2X communication. A range may be provided by a V2X application layer or use a default value mapped in a service type according to the configuration defined in Section TS 23.287 0.3.0 5.1.2.1. The range indicates a minimum distance that should meet the QoS parameter. The range parameter is delivered to an Access Stratum (AS) layer for dynamic control together with the QoS parameter.

NR based PC5 supports communication modes of three types such as broadcast, groupcast and unicast. The QoS processing in different modes is described in Sections TS 23.287v0.3.0 5.4.1.2 to 5.4.1.4.

A UE may process broadcast, groupcast and unicast traffics in consideration of all priorities that can be represented as PQI.

In case of broadcast and groupcast modes of V2X communication over NR based PC5, since there is no signaling over a PC5 reference point in such a case, a standardized PQI value is applied by a UE.

When an operation mode scheduled by a network is used, UE-PC5-AMBR for NR based PC5 applies to communication modes of all types and is used by NG-RAN to cap NR based PC5 transmission of a UE in resource management.

PC5 QoS parameters are described as follows.

1) PQI

PQI is a special 5Qi defined in Section 5.7.2.1 of TS 23.501 and used as a reference to a parameter that controls QoS delivery processing for a packet via PC5 QoS characteristics defined in Section TS 23.287v0.3.0 5.4.3. A standardized PQI value is one-to-one mapped to a standardized combination of PC5 QoS characteristics designated in Table 2 below.

2) PC5 Flow Bit Rates

The following additional Pc5 QoS parameters exist in a GBR QoS flow only.

Guaranteed Flow Bit Rate (GFBR);

Maximum Flow Bit Rate (MFBR).

GFBR and MFBR defined in Section 5.7.2.5 of TS 23.501 are used for the bit rate control of a PC5 reference point through an average time window. In case of PC5 communication, the same GFBR and MFBR are used bidirectionally.

3) PC5 Link Aggregated Bit Rates

A PC5 unicast link is associated with an aggregate rate limit QoS parameter called a total maximum bit rate per link (PC5 LINK-AMBR). The PC5 LINK-AMBR limits an aggregate bit rate expected to be provided to all non-GBR QoS flows via a PC5 unicast link together with a peer UE. The PC5 LINK-AMBR is measured from an AMBR averaging window that is a standardized value. The PC5 LINK-AMBR does not apply to a GBR QoS flow.

4) Range

5) Default Values

A UE may be configured with default values for PC5 QoS parameters with respect to a specific service identified by Provider Service Identifier/ITS-Application Identifier (PSID/ITS-AID) for example. If a corresponding PC5 QoS parameter is not provided by a higher layer, a default value is used.

PC5 QoS characteristics are described as follows.

The standardized or preconfigured PC5 QoS characteristics are represented via PQI values. A higher layer may indicate a specific PC5 QoS characteristic together with a PQI to ignore a standardized or preconfigured value.

1) Resource type

2) Priority level

A priority level has the same format and meaning of PPPP (ProSe Per-Packet Priority) defined in TS 23.285. The priority level is used to process V2X service data differently in different communication modes such as broadcast, groupcast and unicast. If it is unable to fulfill all QoS requirements for all PC5 service data, a priority level is used to select PC5 service data in a manner that PC5 service data having a priority level value N is preferred to PC5 service data having a higher priority level value N+1, N+2, etc. (The smaller the number gets, the higher a priority becomes.)

3) Packet Delay Budget

Packet Delay Budget (PDB) is defined in Section 5.7.3.4 of TS 23.501. Yet, PDB associated with PQI does not include a CN delay configuration element when used for PC5 communication.

4) Packet Error Rate

5) Averaging Window

6) Maximum Data Burst Volume

Maximum Data Burst Volume (MDBV) indicates a maximum volume of data necessary for a PCQ reference point to provide a service within a PDB period of PQI.

Table 2 illustrates Standardized PQI to QoS characteristics mapping.

TABLE 2

| | | | | | Default | | |
|---|---|---|---|---|---|---|---|
| | | Default | Packet | Packet | Maximum | Default [symbol] | |
| PQI [symbol] | Resource | Priority | Delay | Error [symbol] | Data Burst | Averaging | |
| Value [symbol] | Type [symbol] | Level [symbol] | Budget [symbol] | Rate [symbol] | Volume [symbol] | Window [symbol] | Example Services [symbol] |
| 1↓ | ↓ | 3 [symbol] | 20 ms [symbol] | 10⁻⁴ [symbol] | N/A [symbol] | 2000 ms [symbol] | Platooning between |
| [symbol] | GBR [symbol] | | [symbol] | | | | UEs - Higher degree of |
| | | | | | | | automation; [symbol] |
| | | | | | | | Platooning between UE |
| | | | | | | | and RSU - Higher |
| | | | | | | | degree of automation [symbol] |
| 2↓ | (NOTE 1) [symbol] | 4 [symbol] | 50 ms [symbol] | 10⁻² [symbol] | N/A [symbol] | 2000 ms [symbol] | Sensor sharing - higher |
| [symbol] | | | | | | | degree of automation [symbol] |
| 3 [symbol] | [symbol] | 3 [symbol] | 100 ms [symbol] | 10⁻⁴ [symbol] | N/A [symbol] | 2000 ms [symbol] | Information sharing for |
| | | | | | | | automated driving - |
| | | | | | | | between UEs or UE |
| | | | | | | | and RSU - higher |
| | | | | | | | degree of automation [symbol] |
| 55 [symbol] | Non-GBR [symbol] | 3 [symbol] | 10 ms [symbol] | 10⁻⁴ [symbol] | N/A [symbol] | N/A [symbol] | Cooperative lane |
| | | | | | | | change - higher degree |
| | | | | | | | of automation [symbol] |
| 56 [symbol] | [symbol] | 6 [symbol] | 20 ms [symbol] | 10⁻¹ [symbol] | N/A [symbol] | N/A [symbol] | Platooning informative |
| | | | | | | | exchance - low degree |
| | | | | | | | of automation; [symbol] |
| | | | | | | | Platooning - |
| | | | | | | | information sharing with |
| | | | | | | | RSU [symbol] |
| 57 [symbol] | [symbol] | 5 [symbol] | 25 ms [symbol] | 10⁻¹ [symbol] | N/A [symbol] | N/A [symbol] | Cooperative lane |
| | | | | | | | change - lower degree |
| | | | | | | | of automation [symbol] |
| 58 [symbol] | [symbol] | 4 [symbol] | 100 ms [symbol] | 10⁻² [symbol] | N/A [symbol] | N/A [symbol] | Sensor information |
| | | | | | | | sharing - lower degree |
| | | | | | | | of automation [symbol] |
| 59 [symbol] | [symbol] | 6 [symbol] | 500 ms [symbol] | 10⁻¹ [symbol] | N/A [symbol] | N/A [symbol] | Platooning - reporting |
| | | | | | | | to an RSU [symbol] |
| 82 [symbol] | Delay | 3 [symbol] | 10 ms↓ | 10⁻⁴ [symbol] | 2000 bytes [symbol] | 2000 ms [symbol] | Cooperative collision |
| | Critical | | [symbol] | | | | avoidance; [symbol] |
| | GBR [symbol] | | | | | | Sensor sharing - |
| | | | | | | | Higher degree of |
| | | | | | | | automation; [symbol] |
| | | | | | | | Video sharing - higher |
| | | | | | | | degree of automation [symbol] |
| 83 [symbol] | (NOTE 1) [symbol] | 2 [symbol] | 3 ms [symbol] | 10⁻⁵ [symbol] | 2000 byte [symbol] | 2000 ms [symbol] | Emergency trajectory |
| | | | | | | | alignment; [symbol] |
| | | | | | | | Sensor sharing - |
| | | | | | | | Higher degree of |
| | | | | | | | automation [symbol] |

There are following issues in relation to NR PC5 QoS model.

1) For QoS (e.g., QoS requirements), being inputted from an application layer to a V2X layer and being outputted by the V2X layer (e.g., QoS parameters)
Broadcast, groupcast, unicast
non IP communication, IP communication

2) SLRB (Sidelink Radio Bearer) generation time and method and SDAP (Service Data Adaptation Protocol) configuration time and method

3) Mode 1 (network scheduled operation mode), Mode 2 (UE autonomous resources selection mode)

To solve the above issue, a method of efficiently managing a QoS for a PC5 operation is described as follows. In the following description, a traffic may be construed as including both signaling and data transmitted via PC5.

A method of efficiently managing a QoS for a PC5 operation in the 3GPP 5G system (e.g., 5G mobile communication system, next generation system) proposed in the present disclosure includes a combination of one or more operations/configurations/steps in the following. A method proposed below may directly apply to UE-to-UE direct communication such as V2X service, Direct-to-Direct (D2D), Proximity based Services (ProSe) and the like.

A first UE according to one embodiment may derive a plurality of QoS (Quality of Service) parameters for a plurality of services each. The first UE may assign PFIs (PC5 QoS Flow Identifiers) to a plurality of the services based on a plurality of the PC5 QoS parameters, respectively. Here, although the same PC5 QoS parameter is derived from two or more of a plurality of the services, different PFIs may be assigned to the two or more services, respectively. In addition, a plurality of the services may be related to one PC5 unicast link between the first UE and a second UE. By the above configuration, it is able to solve a problem of difficulty in service identification due to the same flow ID in case that several services are related to one PC5 unicast between the first UE and the second UE in the related art. More specifically, in unicast, in case that a plurality of services (e.g., services identified by PSID or ITS-AID) use the same unicast link, although the same PC5 QoS parameters are derived for the different services, a UE may need to generate a different PFI for each of the services. Namely, as the PC5 QoS parameters are identical for the different services, when a packet is actually transmitted via a unicast link, a UE having received the packet may not be able to identify that the received packet is associated with which service.

Regarding the above description, in case of V2X communication over NR PC5 reference point, a PC5 QoS flow is the smallest unit of QoS classification at the same destination identified by Destination Layer-2 ID. A user plane traffic having the same PFI receives the same traffic delivery processing (e.g., a reserved, allowed threshold). A PFI is unique within the same target (destination). A UE assigns a PFI based on PC5 QoS parameters derived or provided by a V2X application layer. Instead, a PFI may be assigned uniquely within a UE irrespective of a destination. Alternatively, a PFI may be uniquely assigned within the same communication mode type, i.e., broadcast, groupcast or unicast. In addition, the UE maintains the mapping of PFI to PC5 QoS parameter in a context per destination. When the UE assigns a new PFI, the UE saves the PFI to a context for a destination together with a corresponding PC5 QoS parameter. If the UE releases the PFI, the UE removes the PFI from the context for the destination. This enables the UE to determine whether a V2X packet from a V2X application layer corresponds to an existing PFI. In case of unicast, a unicast link file defined in Section TS 23.287v0.3.0 5.2.1.4 may be used as a context to store a PFI and a corresponding PC5 QoS parameter. In the above description, when a new PFI is assigned and saved in the context together with the corresponding PC5 QoS parameters, an associated service information may need to be stored as well. This may apply to unicast only or all the unicast/groupcast/broadcast. A plurality of the services may be identified by Provider Service Identifier (PSID) or ITS Application Identifier (ITS-AID).

Subsequently, the PFI may be delivered to the second UE via a PC5-S message, e.g., a Direct Communication Request message or a Link Modification Request message. Namely, the first UE may correspond to a UE starting PC5 unicast link establishment or a UE initiating modification of the established PC5 unicast link. The PC-5 message may include a PC5 QoS parameter corresponding to the PFI. Additionally, service information (this may include the service type (e.g., PSID or ITS-AID) may need to be included in each PC5 QoS Flow (or PFI). Namely, the PFI, the PC5 QoS parameter corresponding to the PFI, and the service information may be delivered to the second UE via the PC5-S message. In a manner that an information element is configured to include information on PC5 QoS Flow(s) for each service, the service information associated with each PC5 QoS Flow may be provided to a counter UE. The PC5 QoS parameters information may be included or not. When such information is included, PQI information may be included only instead of all parameters. Moreover, Application Layer ID information (i.e., source Application Layer ID and/or destination Application Layer ID) associated with PC5 QoS Flow or a service thereof may be included. Namely, in case of unicast, a UE starting the PC5 unicast link establishment assigns PFI(s) such as 1, 2, 3 and the like and includes the assigned PFI(s) in the PC5-S message together with the related PC5 QoS parameters, thereby providing the assigned PFI(s) to a peer UE. In addition, with respect to the established PC5 unicast link, a UE initiating the PC5 unicast link modification to add some PC5 QoS Flow(s) assigns PFI(s) and provides the assigned PFI(s) to the peer UE.

Each of a plurality of the PC5 QoS parameters may be derived from a V2X layer in a manner of using PC5 QoS requirements provided by an application layer as input. Alternatively, each of a plurality of the PC5 QoS parameters may correspond to a default value for the PC5 QoS parameter based on that PC5 QoS related information is not provided by the application layer.

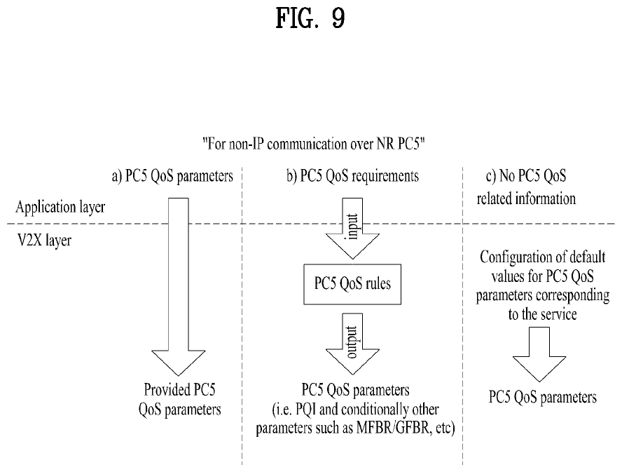

The above two cases may correspond to FIG. 9b) and FIG. 9c), respectively. FIG. 9 illustrates a method of deriving PC5 QoS parameters for non-IP communication over NR PC5. FIG. 9a) shows that an application layer directly provides PC5 QoS parameters. In FIG. 9, PC5 QoS rules may be preconfigured by a UE, or provided or updated in a manner of being signaled via an N1 reference point from a PCF of HPLMN or via a V1 reference point from a V2X Application server in case of being in a coverage.

Regarding the above contents, in relation to FIG. 9a) and FIG. 9b) for the non-IP communication over an NR PC5 reference point, a timing for a V2X application layer to provide PC5 QoS parameters or PC5 QoS requirements to a V2X layer is described as follows.

In broadcast, a V2X application layer provides PC5 QoS parameters or PC5 QoS requirements to a V2X layer together with a V2X packet each time transmitting the V2X packet.

In groupcast, a V2X application layer may provide PC5 QoS parameters or PC5 QoS requirements when providing group identifier information (i.e., application layer V2X group identifier) to a V2X layer (Step 2 of Section TS 23.287v0.3.0 6.3.2).

When transmitting a V2X packet, a V2X application layer may provide PC5 QoS parameters or PC5 QoS requirements to a V2X layer together with the V2X packet.

In unicast, when providing application information for PC5 unicast communication to a V2X layer, a V2X application layer may provide PC5 QoS parameters or PC5 QoS requirements (Step 2 of Section TS 23.287v0.3.0 6.3.3.1). A set of a plurality of PC5 QoS parameters of requirements may be provided from the V2X application layer.

When transmitting a V2X packet, a V2X application layer may provide PC5 QoS parameters or PC5 QoS requirements to a V2X layer together with the V2X packet. Particularly, if a plurality of PC5 QoS flows are included in a PC5 unicast link, the V2X application layer provides the PC5 QoS parameters or requirements to the V2X layer together with the V2X packet, thereby enabling the V2X layer to determine whether the V2X packet corresponds to which PC5 QoS flow. The V2X application layer may provide additional PC5 QoS parameters or requirements with respect to an established PC5 unicast link. The V2X application layer may enable the V2X layer to remove the PC5 QoS parameters or requirements from the established PC5 unicast link.

During a broadcast, groupcast or unicast operation, when providing an Access Stratum (AS) layer with V2X service data (construed as a V2X packet, a V2X message, etc.) to transmit, a V2X layer of a Tx UE may provide the AS layer with a PFI value associated with the data as well. Based on the PFI value, the AS layer may determine whether to transmit the V2X service data using which SLRB.

In the above description, QoS model and QoS mechanism are mainly disclosed from the perspective of PC5 traffic transmission. This may be extended and applied to PC5 traffic reception as well. Namely, when a UE should receive a PC5 traffic indicating a prescribed destination, it may assign a PFI for reception based on PC5 QoS parameters or generate SLRB for reception. With respect to broadcast/groupcast, PFI/SLRB/PC5-SDAP configuration allocated/generated/configured for transmission may be used for reception. With respect to unicast, PFI/SLRB/PC5-SDAP configuration for reception may be allocated/generated/configured based on its source identifier/address information.

TABLE 3
QoS flow identifier (QFI) (bits 6 to 1 of octet 4)
QFI field contains the QoS flow identifier.

| Bits | | | | | | |
|---|---|---|---|---|---|---|
| 6 | 5 | 4 | 3 | 2 | 1 | |
| 0 | 0 | 0 | 0 | 0 | 0 | no QoS flow identifier assigned |
| 0 | 0 | 0 | 0 | 0 | 1 | QFI 1 to |
| 1 | 1 | 1 | 1 | 1 | 1 | QFI 63 |

The network shall not set the QFI value to 0.
Operation code (bits 8 to 6 of octet 5)

| Bits | | | |
|---|---|---|---|
| 8 | 7 | 6 | |
| 0 | 0 | 1 | Create new QoS flow description |
| 0 | 1 | 0 | Delete existing QoS flow description |
| 0 | 1 | 1 | Modify existing QoS flow description |

All other values are reserved.
E bit (bit 7 of octet 6)
For the ″create new QoS flow description″ operation, the E bit is encoded as follows:

| Bit | |
|---|---|
| 7 | |
| 0 | reserved |
| 1 | parameters list is included |

For the ″Delete existing QoS flow description″ operation, the E bit is encoded as follows:

| Bit | |
|---|---|
| 7 | |
| 0 | parameters list is not included |
| 1 | reserved |

For the ″modify existing QoS flow description″ operation, the E bit is encoded as follows:

| Bit | |
|---|---|
| 7 | |
| 0 | extension of previously provided parameters |
| 1 | replacement of all previously provided parameters |

If the E bit is set to ″parameters list is not included″, the number of parameters field has zero value. If the E bit is set to ″parameters
list is included″, the number of parameters field has non-zero value. If the E bit is set to ″extension of previously provided
parameters″ or ″replacement of all previously provided parameters″, the number of parameters field has non-zero value. If the E bit is
set to ″extension of previously provided parameters″ and one of the parameters in the new parameters list already exists in the
previously provided parameters, the parameter shall be set to the new value.
Number of parameters (bits 6 to 1 of octet 6)
The number of parameters field contains the binary coding for the number of parameters in the parameters list field. The number of
parameters field is encoded in bits 6 through 1 of octet 6 where bit 6 is the most significant and bit 1 is the least significant bit.
Parameters list (octets 7 to u)
The parameters list contains a variable number of parameters.
Each parameter included in the parameters list is of variable length and consists of:

| | |
|---|---|
| - | a parameter identifier (1 octet); |
| - | the length of the parameter contents (1 octet); and |
| - | the parameter contents itself (variable amount of octets). |

The parameter identifier field is used to identify each parameter included in the parameters list and it ccntains the hexadecimal
coding of the parameter identifier. Bit 8 of the parameter identifier field contains the most significant bit and bit 1 contains the least
significant bit. In this version of the protocol, the following parameter identifiers are specified:

| | |
|---|---|
| - | 01H (5QI); |
| - | 02H (GFBR uplink); |
| - | 03H (GFBR downlink); |
| - | 04H (MFBR uplink); |
| - | 05H (MFBR downlink); |
| - | 06H (Averaging window); and |
| - | 07H (EPS bearer identity). |

...

TABLE 4
QoS rule identifier (octet 4)
The QoS rule identifier field is used to identify the QoS rule.

| Bits | | | | | | | | |
|---|---|---|---|---|---|---|---|---|
| 8 | 7 | 6 | 5 | 4 | 3 | 2 | 1 | |
| 0 | 0 | 0 | 0 | 0 | 0 | 0 | 0 | no QoS rule identifier assigned |
| 1 | 0 | 0 | 0 | 0 | 0 | 0 | 1 | QRI to |
| 1 | 1 | 1 | 1 | 1 | 1 | 1 | 1 | QRI 255 |

The network shall not set the QRI value to 0.
...
Packet filter component type identifier

| Bits | | | | | | | | |
|---|---|---|---|---|---|---|---|---|
| 8 | 7 | 6 | 5 | 4 | 3 | 2 | 1 | |
| 0 | 0 | 0 | 0 | 0 | 0 | 0 | 1 | Match-all type |
| 0 | 0 | 0 | 1 | 0 | 0 | 0 | 0 | IPv4 remote address type |
| 0 | 0 | 0 | 1 | 0 | 0 | 0 | 1 | IPv4 local address type |
| 0 | 0 | 1 | 0 | 0 | 0 | 0 | 1 | IPv6 remote address/prefix length type |
| 0 | 0 | 1 | 0 | 0 | 0 | 1 | 1 | IPv6 local address/prefix length type |
| 0 | 0 | 1 | 1 | 0 | 0 | 0 | 0 | Protocol identifier/Next header type |
| 0 | 1 | 0 | 0 | 0 | 0 | 0 | 0 | Single local port type |
| 0 | 1 | 0 | 0 | 0 | 0 | 0 | 1 | Local port range type |
| 0 | 1 | 0 | 1 | 0 | 0 | 0 | 0 | Single remote port type |
| 0 | 1 | 0 | 1 | 0 | 0 | 0 | 1 | Remote port range type |
| 0 | 1 | 1 | 0 | 0 | 0 | 0 | 0 | Security parameter index type |
| 0 | 1 | 1 | 1 | 0 | 0 | 0 | 0 | Type of service/Traffic class type |
| 1 | 0 | 0 | 0 | 0 | 0 | 0 | 0 | Flow label type |
| 1 | 0 | 0 | 0 | 0 | 0 | 0 | 1 | Destination MAC address type |
| 1 | 0 | 0 | 0 | 0 | 0 | 1 | 0 | Source MAC address type |
| 1 | 0 | 0 | 0 | 0 | 0 | 1 | 1 | 802.1Q C-TAG VID type |
| 1 | 0 | 0 | 0 | 0 | 1 | 0 | 0 | 802.1Q S-TAG VID type |
| 1 | 0 | 0 | 0 | 0 | 1 | 0 | 1 | 802.1Q C-TAG PCP/DEI type |
| 1 | 0 | 0 | 0 | 0 | 1 | 1 | 0 | 802.1Q S-TAG PCP/DEI type |
| 1 | 0 | 0 | 0 | 0 | 1 | 1 | 1 | Ethertype type |

All other values are reserved.
...

Hereinafter, Tables 5 to 29 are contribution documents prepared/submitted by the applicant of the present disclosure in connection with the above description.

TABLE 5

| | |
|---|---|
| SA WG2 Meeting #133 | S2-19vvvvv |
| 13-17 May, 2019, Reno, Nevada, USA | (revision of S2-19xxxxx) |

| | |
|---|---|
| Source: | LG Electronics |
| Title: | TS 23.287 NR PC5 QoS |
| Document for: | Approval |
| Agenda Item: | 6.6 |

| | |
|---|---|
| Work Item/Release: | eV2XARC/Rel-16 |

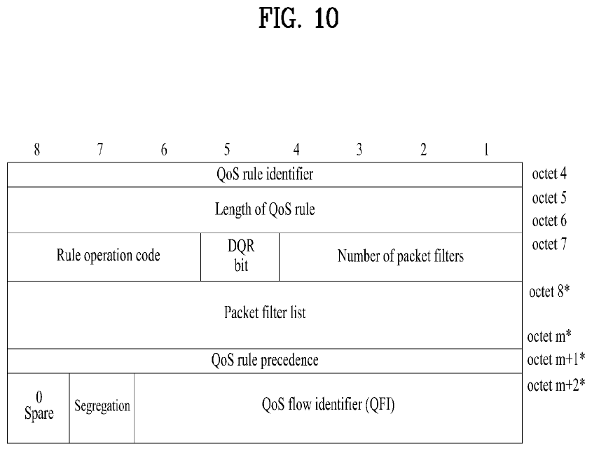

Abstract of the contribution: This paper proposes to discuss and define details of NR PC5
QoS model.
1. Discussion
[1] ″PC5 QoS rule″ - Input from Application layer and Output by V2X layer
According to QoS mechanisms for Uu defined in TS 23.501 and TS 23.502, UE receives
QoS rules mainly including ″Packet filter″ information and ″QFI″ from SMF while
SDAP configuration mainly including ″mapping between QoS Flow to DRB″
information is provided by NG-RAN to UE. In addition, QoS flow descriptions mainly
including PQI, MFBR/GFBR, etc can be optionally provided by SMF to UE.
FIG. 10: QoS rule (u = m + 2)//excerpted from TS 24.501
RadioBearerConfig information element//excerpted from TS 38.331
-- ASN1START
-- TAG-RADIOBEARERCONFIG-START

| RadioBearerConfig ::= | SEQUENCE { | |
|---|---|---|
| srb-ToAddModList | SRB-ToAddModList | OPTIONAL, -- |
| Cond HO-Conn | | |
| srb3-ToRelease | ENUMERATED{true} | OPTIONAL, -- |
| Need N | | |
| drb-ToAddModList | DRB-ToAddModList | OPTIONAL, -- |
| Cond HO-toNR | | |
| drb-ToReleaseList | DRB-ToReleaseList | OPTIONAL, -- Need |
| N | | |
| securityConfig | SecurityConfig | OPTIONAL, -- Need M |
| ... | | |
| } | | |
| SRB-ToAddModList ::= | SEQUENCE (SIZE (1..2)) OF SRB-ToAddMod | |
| SRB-ToAddMod ::= | SEQUENCE { | |
| srb-Identity | SRB-Identity, | |
| reestablishPDCP | ENUMERATED{true} | OPTIONAL, -- |
| Need N | | |
| discardOnPDCP | ENUMERATED{true} | OPTIONAL, -- |
| Need N | | |
| pdcp-Config | PDCP-Config | OPTIONAL, -- Cond |
| PDCP | | |
| ... | | |
| } | | |
| DRB-ToAddModList ::= | SEQUENCE (SIZE (1..maxDRB)) OF DRB- | |
| ToAddMod | | |
| DRB-ToAddMod ::= | SEQUENCE { | |
| cnAssociation | CHOICE { | |
| eps-BearerIdentity | INTEGER (0..15), | EPS-DRB- |
| Setup | | |
| sdap-Config | SDAP-Config | 5GC |

| | |
|---|---|
| } | OPTIONAL, -- Cond DRB Setup |

| | | |
|---|---|---|
| drb-Identity | DRB-Identity, | |
| reestablishPDCP | ENUMERATED{true} | OPTIONAL, -- |
| Need N | | |
| recoverPDCP | ENUMERATED{true} | OPTIONAL, -- |
| Need N | | |
| pdcp-Config | PDCP-Config | OPTIONAL, -- Cond |
| PDCP | | |
| ... | | |
| } | | |

| | |
|---|---|
| DRB-ToReleaseList ::= | SEQUENCE (SIZE (1..maxDRB)) OF DRB-Identity |

TABLE 6

| | |
|---|---|
| SecurityConfig ::= | SEQUENCE { |
| securityAlgorithmConfig | SecurityAlgorithmConfig OPTIONAL, |
| -- Cond RBTermChange | |
| keyToUse | ENUMERATED{master, secondary} |

OPTIONAL, -- Cond RBTermChange
...
}
-- TAG-RADIOBEARERCONFIG-STOP
-- ASN1STOP
SDAP-Config information element//excerpted from TS 38.331
-- ASN1START
-- TAG-SDAP-CONFIG-START

| | |
|---|---|
| SDAP-Config ::= | SEQUENCE { |
| pdu-Session | PDU-SessionID, |
| sdap-HeaderDL | ENUMERATED {present, absent}, |
| sdap-HeaderUL | ENUMERATED {present, absent}, |
| defaultDRB | BOOLEAN, |
| mappedQoS-FlowsToAdd | SEQUENCE (SIZE (1..maxNrofQFIs)) OF |

QFI OPTIONAL, -- Need N

| | |
|---|---|
| mappedQoS-FlowsToRelease | SEQUENCE (SIZE (1..maxNrofQFIs)) |

OF QFI OPTIONAL, -- Need N
...
}

| | |
|---|---|
| QFI ::= | INTEGER (0..maxQFI) |

| | |
|---|---|
| PDU-SessionID ::= | INTEGER (0..255) |

-- TAG-SDAP-CONFIG-STOP
-- ASN1 STOP
Table 3: QoS flow descriptions information element//excerpted from TS 24.501
First, unlike Uu communication which NG-RAN manages DRBs, we think that UE is able
to perform establishment, configuration, maintenance and release of SLRBs (SideLink
Radio Bearers) because UE has good knowledge on which V2X services it uses and PC5
operations have to also work out of coverage case.
Proposal#1: It is proposed that UE performs establishment, configuration,
maintenance and release of SLRBs (SideLink Radio Bearers).
In order to get the UE manage SLRBs, we propose that PFI (PC5 QoS Flow Identifier) is
assigned by the UE. Details of PFI is discussed in [2] below.
Proposal#2: It is proposed that UE assigns PFI (PC5 QoS Flow Identifier) for PC5 QoS
Flow.
As explained above, there are QoS rules and QoS flow descriptions for Uu QoS
mechanisms. For NR PC5 QoS mechanisms, we propose to define ″PC5 QoS rules″ that are
combination of QoS rules and QoS flow descriptions which means ″PC5 QoS rules″
generate PC5 QoS parameters defined in clause 5.4.2 ″PC5 QoS parameters″ (i.e. PQI and
conditionally other parameters such as MFBR/GFBR, etc) as output. Because PFI is
assigned by the UE, ″PC5 QoS rules″ do not have to generate PFI as output.
Proposal#3: It is proposed to define ″PC5 QoS rules″ that generate PC5 QoS
parameters defined in clause 5.4.2 ″PC5 QoS parameters″ (i.e. PQI and conditionally
other parameters such as MFBR/GFBR, etc) as output.
Let's think of which information can be used as input for ″PC5 QoS rules″ to derive PC5 QoS
parameters. In QoS rules for Uu, ″packet filter″ information is used as input.

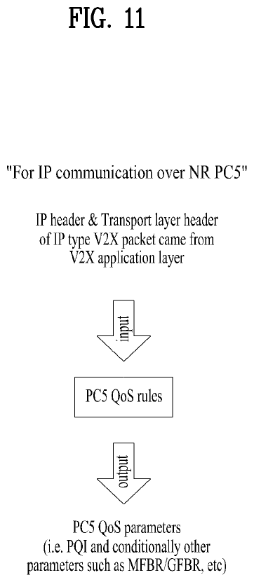

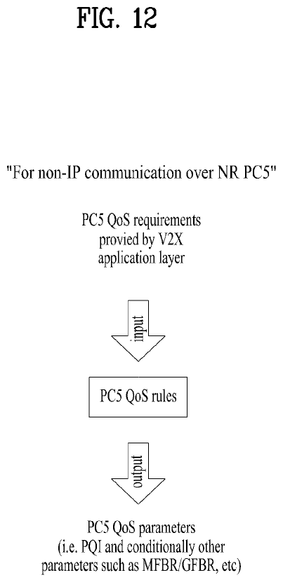

TABLE 7
For IP communication over PC5 reference point, similar to Uu IP communication, “packet
filter” information can be used as input to derive PC5 QoS parameters. This means that
when V2X application layer sends V2X packet, V2X layer derives PC5 QoS parameters for
the V2X packet based on “PC5 QoS rules” by using information of IP header and transport
layer header as packet filter.
FIG. 11: For IP communication over NR PC5, input and output for PC5 QoS rules
Proposal#4: It is proposed that for IP communication over PC5 reference point,
“packet filter” information is used to derive PC5 QoS parameters by V2X layer. This
means that when V2X application layer sends V2X packet, V2X layer derives PC5 QoS
parameters for the V2X packet based on ″PC5 QoS rules″ by using information of IP
header and transport layer header as packet filter.
For non-IP communication over PC5 reference point, the following operations to derive
PC5 QoS parameters can be applied:
a) When V2X application layer provides PC5 QoS parameters (i.e. PQI and
conditionally other parameters) to V2X layer, the V2X layer uses the provided
PC5 QoS parameters;
b) When V2X application layer provides PC5 QoS requirements, e.g. priority
requirement, reliability requirement, delay requirement, to V2X layer, the V2X
layer derives PC5 QoS parameters based on ″PC5 QoS rules″ by using the
provided PC5 QoS requirements as input;
c) Otherwise, i.e. when V2X application layer does not provide any PC5 QoS
related information to V2X layer, default values for PC5 QoS parameters
corresponding to the service (e.g. PSID/ITS-AID) are used.
FIG. 12: For non-IP communication over NR PC5, input and output for PC5 QoS
rules
Proposal#5: It is proposed that for non-IP communication over PC5
reference point, the V2X layer performs a), b) and c) to derive PC5 QoS
parameters. For b), PC5 QoS requirements provided by V2X application
layer are used as input to “PC5 QoS rules”.
Regarding a) and b) for non-IP communication over PC5 reference point the followings are
assumed regarding when the V2X application layer provides PC5 QoS parameters or PC5
QoS requirements to the V2X layer.
For broadcast,
The V2X application layer provides PC5 QoS parameters or PC5 QoS
requirements together with V2X packet to the V2X layer whenever sending the
V2X packet.
For groupcast,
The V2X application layer may provide PC5 QoS parameters or PC5 QoS
requirements when providing group identifier information (i.e. an Application-layer
V2X Group identifier) to the V2X layer (step 2 of clause 6.3.2).
Also, the V2X application layer may provide PC5 QoS parameters or PC5 QoS
requirements together with V2X packet to the V2X layer when sending V2X
packet.
For unicast,
The V2X application layer may provide PC5 QoS parameters or PC5 QoS
requirements when providing application information for PC5 unicast communication to the
V2X layer (step 2 of clause 6.3.3.1). Multiple sets of PC5 QoS parameters or PC5 QoS
requirements may be provided from the V2X application layer.

TABLE 8
The V2X application layer may provide PC5 QoS parameters or PC5 QoS
requirements together with V2X packet to the V2X layer when sending V2X
packet. In particular, if a PC5 unicast link includes multiple PC5 QoS Flows, the
V2X application layer needs to provide PC5 QoS parameters or PC5 QoS
requirements together with V2X packet to the V2X layer so that the V2X layer can
determine which PC5 QoS Flow the V2X packet corresponds to.
The V2X application layer may provide additional PC5 QoS parameters or PC5
QoS requirements for the established PC5 unicast link.
The V2X application layer may remove any PC5 QoS parameters or PC5 QoS
requirements from the established PC5 unicast link by indicating this to the V2X
layer.
In case of IP communication over NR PC5, like non-IP communication over NR PC5, PC5
QoS requirements information provided by a V2X application layer may be used as an input
of PC5 QoS rules.
Similar to other V2X parameters, PC5 QoS rules” can be pre-configured in the UE, or, if in
coverage, provisioned or updated by signalling over the N1 reference point from the PCF in the HPLMN or over VI reference point from the V2X Application Server.
Proposal#6: It is proposed that ″PC5 QoS rules″ can be pre-configured in the UE, or,
if in coverage, provisioned or updated by signalling over the N1 reference point from
the PCF in the HPLMN or over VI reference point from the V2X Application Server.
[2] PFI (PC5 QoS Flow Identifier)
For Uu communication, the QoS Flow is the finest granularity of QoS differentiation in the
PDU Session. For PC5 communication, we think that the PC5 QoS Flow is the finest
granularity of QoS differentiation in the same destination identified by Destination Layer-2
ID.
Proposal#7: It is proposed that for V2X communication over NR PC5, the PC5 QoS
Flow is the finest granularity of QoS differentiation in the same destination identified
by Destination Layer-2 ID.
Or, it is proposed that for V2X communication over NR PC5, the PC5 QoS Flow is the
finest granularity of QoS differentiation in the same destination identified by
Destination Layer-2 ID and same communication mode (i.e. broadcast, groupcast or
unicast). In this case, ‘per Destination’ described or illustrated below should be
construed as ‘per Destination per communication mode’.
Although the destination is described as identified by Destination Layer-2 ID, other
identifiers (e.g., Destination IP address information, etc.) may be used instead or in addition
thereto.
User Plane traffic with the same PFI receives the same traffic forwarding treatment (e.g.
scheduling, admission threshold). The PFI is unique within a same destination. The UE
assigns PFI based on the PC5 QoS parameters derived or provided by V2X application
layer.
For unicast, the UE initiating PC5 unicast link establishment assigns PFI(s) such as 1, 2, 3
and etc, and provides the assigned PFI(s) to the peer UE by including the assigned PFI(s)
with the related PC5 QoS parameters in a Direct Communication Request message. In
addition, for the established PC5 unicast link, the UE initiating PC5 unicast link
modification to add some PC5 QoS Flow(s) assigns PFI(s) and provides the assigned PFI(s)
to the peer UE.
Proposal#8: It is proposed that the PFI is unique within a same destination. The UE
assigns PFI based on the PC5 QoS parameters derived or provided by V2X application
layer.
Proposal#9: It is proposed that for unicast, the UE initiating PC5 unicast link
establishment assigns PFI(s) such as 1,2, 3 and etc, and provides the assigned PFI(s) to
the peer UE by including the assigned PFI(s) with the related PC5 QoS parameters in
a Direct Communication Request message.

TABLE 9
Proposal#10: It is proposed that for the established PC5 unicast link, the UE initiating
PC5 unicast link modification to add some PC5 QoS Flow(s) assigns PFI(s) and
provides the assigned PFI(s) to the peer UE.
When the UE assigns a new PFI, the UE stores it with the corresponding PC5 QoS
parameters in a context for the destination. When the UE releases the PFI, the UE removes it
from a context for the destination. The enables for the UE to determine whether V2X packet
from the V2X application layer corresponds to existing PFI.
Proposal#11: It is proposed that the UE maintains mapping of PFI to PC5 QoS
parameters in a context per destination.
[3] SLRB establishment/release
Regarding SLRB establishment, the followings are applied:
- The UE performs SLRB establishment when it decides new SLRB is needed to deliver
PC5 QoS Flow(s).
- The UE establishes at least one SLRB for any destination and additional SLRB(s) for
PC5 QoS flow(s) of that destination can be subsequently established.
The UE maps V2X packets belonging to different destinations to different SLRBs.
Proposal#!!: It is proposed that the UE establishes at least one SLRB for any
destination and additional SLRB(s) for PC5 QoS flow(s) of that destination can be
subsequently established.
The UE may perform SLRB release in the following cases:
For broadcast, when the UE determines the SLRB is not needed anymore, e.g. based
on information from the V2X application layer that the related service was stopped or
completed resulting in removal of the corresponding PC5 QoS Flow(s) and PFI(s),
when an implementation dependent inactivity timer for the SLRB expired.
For groupcast, when the UE determines the SLRB is not needed anymore, e.g. based
on information from the V2X application layer that the related group communication
was over or stopped resulting in removal of the corresponding PC5 QoS Flow(s) and
PFI(s), when an implementation dependent inactivity timer for the SLRB expired.
For unicast, when the UE determines the SLRB is not needed anymore, e.g. when the
PC5 unicast link was released, when the related PC5 QoS Flow(s) and PFI(s) were
removed from the PC5 unicast link.
Proposal#13: It is proposed that the UE may perform SLRB release when the UE
determines the SLRB is not needed anymore.
[4] PC5-SDAP configuration
Several PC5-SDAP entities may be defined for a UE. A single entity of PC5-SDAP is
configured for each destination.
Proposal#14: It is proposed that several PC5-SDAP entities may be defined for a UE
and a single entity of PC5-SDAP is configured for each destination.
The UE performs PC5-SDAP (re)configuration as below:
For a new PC5 QoS Flow, the UE adds mapping between the PC5 QoS Flow (i.e. PFI)
and an SLRB to the corresponding PC5-SDAP entity. In this case, when there is no
PC5-SDAP entity, the UE first establishes a PC5-SDAP entity.
For a removed PC5 QoS Flow, the UE deletes mapping between the PC5 QoS Flow
(i.e. PFI) and an SLRB from the corresponding PC5-SDAP entity. In this case, the UE
releases the PC5-SDAP entity when no mapping is left in the PC5-SDAP entity.

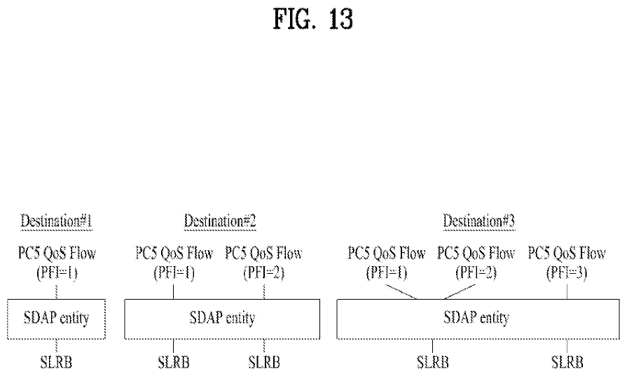

```
TABLE 10
Proposal#15: It is proposed that the UE performs PC5-SDAP (re)configuration for a
new PC5 QoS Flow and for a removed PC5 QoS Flow.
FIG. 13: An example mapping between PC5 QoS Flow and SLRB
----------------
[1] to [4] explained above and all proposals are applied to Mode 1 and Mode 2.
2. Proposal
It is proposed to agree the following changes into TS 23.287.
* * * * Start of Changes * * * *
5.4.1 QoS handling for V2X communication over PC5 reference point
5.4.1.1 QoS model
5.4.1.1.1 General overview
For LTE based PC5, the QoS handling is defined in TS 23.285 [8], based on ProSe Per-
Packet Priority (PPPP) and ProSe Per-Packet Reliability (PPPR).
For NR based PC5, a QoS model similar to that defined in TS 23.501 [6] for Uu reference
point is used, i.e. based on 5QIs, with additional parameter of Range. For the V2X
communication over NR based PC5 reference point, a PC5 QoS Flow is associated with a
PC5 QoS rule that contains the PC5 QoS parameters as defined in clause 5.4.2. A set of
standardized PC5 5QIs (PQI) are defined in clause 5.4.4. The UE may be configured with a
set of default PC5 QoS parameters to use for the V2X services, as defined in clause 5.1.2.1.
For NR based unicast, groupcast and broadcast PC5 communication, Per-flow QoS model
for PC5 QoS management shall be applied. Figure 5.4.1.1.1-1 illustrates an example
mapping of Per-flow QoS model for NR PC5. Details of PC5 QoS rules and PFI are
described in clause 5.4.1.1.2 while PC5-SDAP sublayer and mapping between PC5 QoS
Flow and SideLink Radio Bearer (SLRB) are described in clause 5.4.1.1.3.
FIG. 8: Per-Flow PC5 QoS Model for NR PC5
The following principles apply when the V2X communication is carried over PC5 reference
point:
      Application layer may set the QoS requirements for the V2X communication, using
either TS 23.285 [8] defined PPPP and PPPR model or the PQI and Range model. Depends
on the type of PC5 reference point, i.e. LTE based or NR based, selected for the
transmission, the UE may map the application layer provided QoS requirements to the
suitable QoS parameters to be passed to the lower layer. The mapping between the two QoS
models is defined in clause 5.4.2.
      When groupcast or unicast mode of V2X communication over NR based PC5 is
used, a Range parameter is associated with the QoS parameters for the V2X communication.
The Range may be provided by V2X application layer or use a default value mapped from
the service type based on configuration as defined in clause 5.1.2.1. The Range indicates the
minimum distance that the QoS parameters need to be fulfilled. The Range parameter is
passed to AS layer together with the QoS parameters for dynamic control.
      NR based PC5 supports three types of communication mode, i.e. broadcast,
groupcast, and unicast. The QoS handling of these different modes are described in
clauses 5.4.1.2 to 5.4.1.4.
```

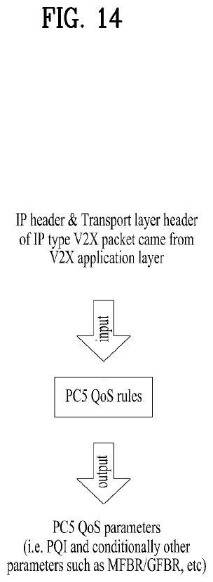

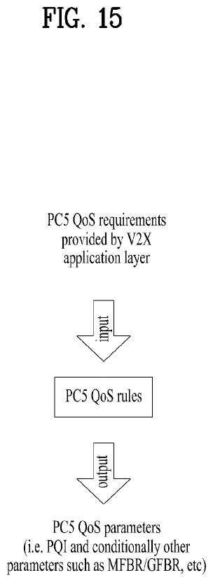

```
TABLE 11
    The UE may handle broadcast, groupcast, and unicast traffic by taking all their
    priorities, e.g. indicated by PQIs, into account.
    For broadcast and groupcast modes of V2X communication over NR based PC5,
    standardized PQI values are applied by the UE, as there is no signalling over PC5
    reference point for these cases.
    When network scheduled operation mode is used, the UE-PC5-AMBR for NR based
    PC5 applies to all types of communication modes, and is used by NG-RAN for
    capping the UE's NR based PC5 transmission in the resources management.
  Editor's note: The support of new QoS model, including PQI and Range, depends on
        RAN WGs' feedback.
5.4.1.1.2 PC5 QoS rule and PFI
The following description applies to for both network scheduled operation mode and UE
autonomous resources selection mode.
For NR PC5 QoS mechanisms, ″PC5 QoS rules″ is defined to derive PC5 QoS parameters
defined in clause 5.4.2 (i. e. PQI and conditionally other parameters such as MFBR/GFBR,
etc). PFI is not derived from PC5 QoS rules and assigned by the UE.
For IP communication over NR PC5 reference point, similar to IP communication over Uu
reference point, packet filter information can be used as input to derive PC5 QoS
parameters. This means that when V2X application layer sends V2X packet, V2X layer
derives PC5 QoS parameters for the V2X packet based on PC5 QoS rules by using
information of IP header and transport layer header as packet filter, i.e. input.
FIG. 14 illustrates input and output for PC5 QoS rules for IP communication over NR PC5.
FIG. 14: For IP communication over NR PC5, input and output for PC5 QoS rules
For non-IP communication over NR PC5 reference point, the following operations to derive
PC5 QoS parameters are applied:
  a) When V2X application layer provides PC5 QoS parameters (i. e. PQI and conditionally
    other parameters) to V2X layer, the V2X layer uses the provided PC5 QoS
    parameters;
  b) When V2X application layer provides PC5 QoS requirements, e.g. priority
    requirement, reliability requirement, delay requirement, to V2X layer, the V2X layer
    derives PC5 QoS parameters based on PC5 QoS rules by using the provided PC5 QoS
    requirements as input;
  c) Otherwise, i.e. when V2X application layer does not provide any PC5 QoS related
    information to V2X layer, default values for PC5 QoS parameters corresponding to
    the service (e.g. PSID/ITS-AID) are used.
FIG. 15 illustrates input and output for PC5 QoS rules for non-IP communication over NR
PC5.
FIG. 15: For non-IP communication over NR PC5, input and output for PC5 QoS
rules
Regarding a) and b) for non-IP communication over NR PC5 reference point, the followings
are assumed regarding when the V2X application layer provides PC5 QoS parameters or
PC5 QoS requirements to the V2X layer.
    For broadcast,
        The V2X application layer provides PC5 QoS parameters or PC5 QoS
      requirements together with V2X packet to the V2X layer whenever sending the
      V2X packet.
    For groupcast,
        The V2X application layer may provide PC5 QoS parameters or PC5 QoS
      requirements when providing group identifier information (i.e. an Application-
      layer V2X Group identifier) to the V2X layer (step 2 of clause 6.3,2).
```

```
TABLE 12
        Also, the V2X application layer may provide PC5 QoS parameters or PC5
      QoS requirements together with V2X packet to the V2X layer when sending V2X
      packet.
    For unicast,
        The V2X application layer may provide PC5 QoS parameters or PC5 QoS
      requirements when providing application information for PC5 unicast
      communication to the V2X layer (step 2 of clause 6.3.3.1). Multiple sets of PC5
      QoS parameters or PC5 QoS requirements may be provided from the V2X
      application layer.
        The V2X application layer may provide PC5 QoS parameters or PC5 QoS
      requirements together with V2X packet to the V2X layer when sending V2X
      packet. In particular, if a PC5 unicast link includes multiple PC5 QoS Flows, the
      V2X application layer needs to provide PC5 QoS parameters or PC5 QoS
      requirements together with V2X packet to the V2X layer so that the V2X layer
      can determine which PC5 QoS Flow the V2X packet corresponds to.
        The V2X application layer may provide additional PC5 QoS parameters or
      PC5 QoS requirements for the established PC5 unicast link.
        The V2X application layer may remove any PC5 QoS parameters or PC5
      QoS requirements from the established PC5 unicast link by indicating this to the
      V2X layer.
PC5 QoS rules can be pre-configured in the UE, or, if in coverage, provisioned or updated
by signalling over the N1 reference point from the PCF in the HPLMN or over V1 reference
point from the V2X Application Server.
For V2X communication over NR PC5 reference point, the PC5 QoS Flow is the finest
granularity of QoS differentiation in the same destination identified by Destination Layer-2
ID. User Plane traffic with the same PFI receives the same traffic forwarding treatment (e.g.
scheduling, admission threshold). The PFI is unique within a same destination. The UE
assigns PFI based on the PC5 QoS parameters derived or provided by V2X application
layer.
For unicast, the UE initiating PC5 unicast link establishment assigns PFI(s) such as 1, 2, 3
and etc, and provides the assigned PFI(s) to the peer UE by including the assigned PFI(s)
with the related PC5 QoS parameters in a Direct Communication Request message. In
addition, for the established PC5 unicast link, the UE initiating PC5 unicast link
modification to add some PC5 QoS Flow(s) assigns PFI(s) and provides the assigned PFI(s)
to the peer UE.
The UE maintains mapping of PFI to PC5 QoS parameters in a context per destination.
When the UE assigns a new PFI, the UE stores it with the corresponding PC5 QoS
parameters in the context for the destination. When the UE releases the PFI, the UE removes
it from the context for the destination. The enables for the UE to determine whether V2X
packet from the V2X application layer corresponds to existing PFI.
```

| | |
|---|---|
| 5.4.1.1.3 | PC5-SDAP sublayer and Mapping between PC5 QoS Flow and SideLink |
| | Radio Bearer (SLRB) |

```
The following description applies to for both network scheduled operation mode and UE
autonomous resources selection mode.
Regarding SideLink Radio Bearer (SLRB) establishment, the followings are applied:
    The UE performs SLRB establishment when it decides new SLRB is needed to deliver
    PC5 QoS Flow(s).
    The UE establishes at least one SLRB for any destination and additional SLRB(s) for
    PC5 QoS flow(s) of that destination can be subsequently established.
    The UE maps V2X packets belonging to different destinations to different SLRBs.
The UE may perform SLRB release in the following cases:
    For broadcast, when the UE determines the SLRB is not needed anymore, e.g. based
    on information from the V2X application layer that the related service was stopped or
    completed resulting in removal of the corresponding PC5 QoS Flow(s) and PFI(s),
    when an implementation dependent inactivity timer for the SLRB expired.
    For groupcast, when the UE determines the SLRB is not needed anymore, e.g. based
    on information from the V2X application layer that the related group communication
    was over or stopped resulting in removal of the corresponding PC5 QoS Flow(s) and
    PFI(s), when an implementation dependent inactivity timer for the SLRB expired.
```

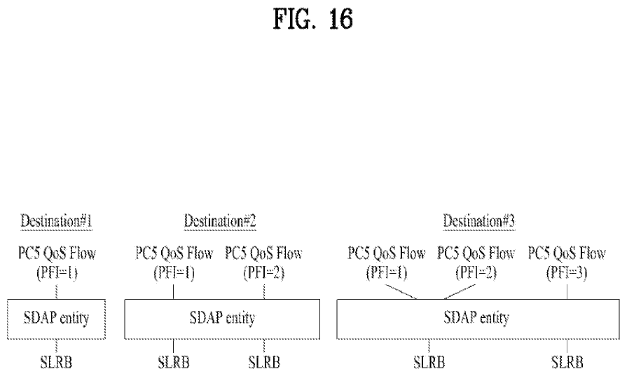

```
TABLE 13
    - For unicast, when the UE determines the SLRB is not needed anymore, e.g.
    when the PC5 unicast link was released, when the related PC5 QoS Flow(s) and
    PFI(s) were removed from the PC5 unicast link.
Several PC5-SDAP entities may be defined for a UE. A single entity of PC5-SDAP is
configured for each destination.
The UE performs PC5-SDAP (re)configuration as below:
    - For a new PC5 QoS Flow, the UE adds mapping between the PC5 QoS Flow
    (i.e. PFI) and an SLRB to the corresponding PC5-SDAP entity. In this case, when
    there is no PC5-SDAP entity, the UE first establishes a PC5-SDAP entity.
    - For a removed PC5 QoS Flow, the UE deletes mapping between the PC5
    QoS Flow (i.e. PFI) and an SLRB from the corresponding PC5-SDAP entity. In
    this case, the UE releases the PC5-SDAP entity when no mapping is left in the
    PC5-SDAP entity.
FIG. 16 shows an example of mapping between PC5 QoS Flow and SLRB.
FIG. 16: An example mapping between PC5 QoS Flow and SLRB
* * * * End of Changes * * * *
1. Discussion
[1] ″PC5 QoS rule″ - Input from Application layer and Output by V2X layer
According to QoS mechanisms for Uu defined in TS 23.501 and TS 23.502, UE receives
QoS rules mainly including ″Packet filter″ information and ″QFI″ from SMF while SDAP
configuration mainly including ″mapping between QoS Flow to DRB″ information is
provided by NG-RAN to UE. In addition, QoS flow descriptions mainly including 5QI,
MFBR/GFBR, etc can be optionally provided by SMF to UE.
FIG. 10: QoS rule (u = m + 2)//excerpted from TS 24.501
Table 4: QoS rules information element
RadioBearerConfig information element//excerpted from TS 38.331
-- ASN1START
-- TAG-RADIOBEARERCONFIG-START
```

| RadioBearerConfig ::= | SEQUENCE { | |
|---|---|---|
| srb-ToAddModList | SRB-ToAddModList | OPTIONAL, -- |
| Cond HO-Conn | | |
| srb3-ToRelease | ENUMERATED{true} | OPTIONAL, -- |
| Need N | | |
| drb-ToAddModList | DRB-ToAddModList | OPTIONAL, -- |
| Cond HO-toNR | | |
| drb-ToReleaseList | DRB-ToReleaseList | OPTIONAL, -- Need N |
| securityConfig | SecurityConfig | OPTIONAL, -- Need M |
| ... | | |
| } | | |
| SRB-ToAddModList ::= | SEQUENCE (SIZE (1..2)) OF SRB-ToAddMod | |
| SRB-ToAddMod ::= | SEQUENCE { | |
| srb-Identity | SRB-Identity, | |
| reestablishPDCP | ENUMERATED{true} | OPTIONAL, -- |
| Need N | | |
| discardOnPDCP | ENUMERATED{true} | OPTIONAL, -- |
| Need N | | |
| pdcp-Config | PDCP-Config | OPTIONAL, -- Cond |
| PDCP | | |
| ... | | |

TABLE 14

| } | | |
|---|---|---|
| DRB-ToAddModList ::= | SEQUENCE (SIZE (1..maxDRB)) OF | |
| DRB-ToAddMod | | |
| DRB-ToAddMod ::= | SEQUENCE { | |
| cnAssociation | CHOICE { | |
| eps-BearerIdentity | INTEGER (0..15), | -- EPS- |
| DRB-Setup | | |
| sdap-Config | SDAP-Config | -- 5GC |

| | |
|---|---|
| } | OPTIONAL, -- Cond |

| DRBSetup | | |
|---|---|---|
| drb-Identity | DRB-Identity, | |
| reestablishPDCP | ENUMERATED{true} | |
| OPTIONAL, -- Need N | | |
| recoverPDCP | ENUMERATED{true} | |
| OPTIONAL, -- Need N | | |
| pdcp-Config | PDCP-Config | OPTIONAL, -- |

| | |
|---|---|
| Cond PDCP | |
| ... | |
| } | |
| DRB-ToReleaseList ::= | SEQUENCE (SIZE (1..maxDRB)) OF DRB- |
| Identity | |
| SecurityConfig ::= | SEQUENCE { |
| securityAlgorithmConfig | SecurityAlgorithmConfig OPTIONAL, |
| -- Cond RBTermChange | |
| keyToUse | ENUMERATED{master, secondary} |

OPTIONAL, -- Cond RBTermChange
...
}
-- TAG-RADIOBEARERCONFIG-STOP
-- ASN1STOP
SDAP-Config information element//excerpted from TS 38.331

| | |
|---|---|
| -- ASN1START | |
| -- TAG-SDAP-CONFIG-START | |
| SDAP-Config ::= | SEQUENCE { |
| pdu-Session | PDU-SessionID, |
| sdap-HeaderDL | ENUMERATED {present, absent}, |
| sdap-HeaderUL | ENUMERATED {present, absent}, |
| defaultDRB | BOOLEAN, |

| | |
|---|---|
| mappedQoS-FlowsToAdd | SEQUENCE (SIZE (1..maxNrofQFIs)) OF |
| QFI OPTIONAL, -- Need N | |
| mappedQoS-FlowsToRelease | SEQUENCE (SIZE (1..maxNrofQFIs)) |

OF QFI OPTIONAL, -- Need N
...
}

| | |
|---|---|
| QFI ::= | INTEGER (0..maxQFI) |

| | |
|---|---|
| PDU-SessionID ::= | INTEGER (0..255) |

-- TAG-SDAP-CONFIG-STOP
-- ASN1 STOP
Table 3: QoS flow descriptions information element//excerpted from TS 24.501
First, unlike Uu communication which NG-RAN manages DRBs, we think that UE is able
to perform establishment, configuration, maintenance and release of SLRBs (SideLink
Radio Bearers) because UE has good knowledge on which V2X services it uses and PC5
operations have to also work for out of coverage case.
Proposal#1: It is proposed that UE performs establishment, configuration,
maintenance and release of SLRBs (SideLink Radio Bearers).
In order to get the UE manage SLRBs, we propose that PFI (PC5 QoS Flow Identifier) is
assigned by the UE. Details of PFI related operations are discussed in [2] below.
Proposal#2: It is proposed that UE assigns PFI (PC5 QoS Flow Identifier) for PC5 QoS
Flow.
As explained above, there are QoS rules and QoS flow descriptions for Uu QoS mechanisms.
For NR PC5 QoS mechanisms, we propose to define ″PC5 QoS rules″ that are combination of
QoS rules and QoS flow descriptions which means ″PC5 QoS rules″ generate PC5 QoS
parameters defined in clause 5.4.2 ″PC5 QoS parameters″ (i.e. PQI and

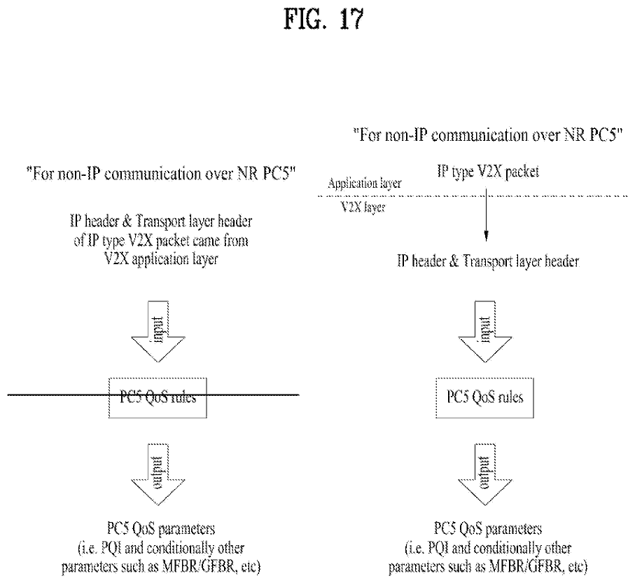

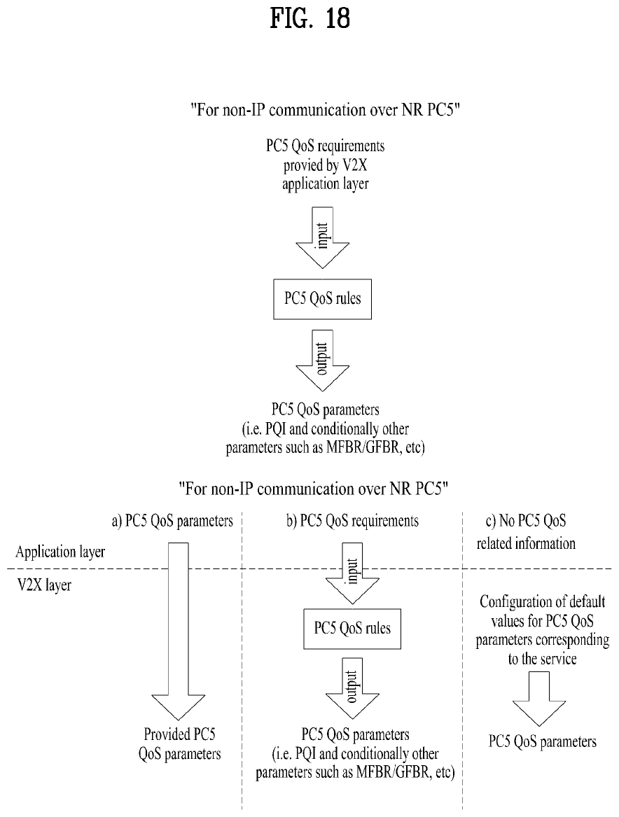

```
TABLE 15
conditionally other parameters such as MFBR/GFBR, etc) as output. Because PFI is
assigned by the UE, ″PC5 QoS rules″ do not have to generate PFI as output.
Proposal#3: It is proposed to define ″PC5 QoS rules″ that generate PC5 QoS
parameters defined in clause 5.4.2 ″PC5 QoS parameters″ (i.e. PQI and conditionally
other parameters such as MFBR/GFBR, etc) as output.
Let's think of which information can be used as input for ″PC5 QoS rules″ to derive PC5
QoS parameters. In QoS rules for Uu, ″packet filter″ information is used as input.
For IP communication over PC5 reference point, similar to Uu IP communication, ″packet
filter″ information can be used as input to derive PC5 QoS parameters. This means that
when V2X application layer sends IP type V2X packet, V2X layer derives PC5 QoS
parameters for the V2X packet based on ″PC5 QoS rules″ by using information of IP header
and transport layer header as packet filter.
FIG. 17: Deriving PC5 QoS parameters for IP communication over NR PC5
Proposal#4: It is proposed that for IP communication over PC5 reference point,
″packet filter″ information is used to derive PC5 QoS parameters by V2X layer. This
means that when V2X application layer sends IP type V2X packet, V2X layer derives
PC5 QoS parameters for the V2X packet based on ″PC5 QoS rules″ by using
information of IP header and transport layer header as packet filter.
For non-IP communication over PC5 reference point, the following operations to derive PC5 QoS parameters can be applied:
    a) When V2X application layer provides PC5 QoS parameters (i.e. PQI and
    conditionally other parameters) to V2X layer, the V2X layer uses the provided
    PC5 QoS parameters;
    b) When V2X application layer provides PC5 QoS requirements, e.g. priority
    requirement, reliability requirement, delay requirement, to V2X layer, the V2X
    layer derives PC5 QoS parameters based on ″PC5 QoS rules″ by using the
    provided PC5 QoS requirements as input;
    c) Otherwise, i.e. when V2X application layer does not provide any PC5 QoS
    related information to V2X layer, the V2X layer uses default values for PC5 QoS
    parameters corresponding to the service (e.g. PSID/ITS-AID).
    FIG. 18: Deriving PC5 QoS parameters for non-IP communication over NR PC5
    Proposal#5: It is proposed that for non-IP communication over PC5
    reference point, the V2X layer performs a), b) and c) to derive PC5 QoS
    parameters. For b), PC5 QoS requirements provided by V2X application
    layer are used as input to ″PC5 QoS rules″.
Regarding a) and b) for non-IP communication over PC5 reference point the followings are
assumed regarding when the V2X application layer provides PC5 QoS parameters or PC5
QoS requirements to the V2X layer.
      For broadcast,
    The V2X application layer provides PC5 QoS parameters or PC5 QoS
    requirements together with V2X packet to the V2X layer whenever sending the
    V2X packet.
      For groupcast,
    The V2X application layer may provide PC5 QoS parameters or PC5 QoS
    requirements when providing group identifier information (i.e. an Application-layer
    V2X Group identifier) to the V2X layer (step 2 of clause 6.3.2).
```

```
TABLE 16
    The V2X application layer may provide PC5 QoS parameters or PC5 QoS
    requirements together with V2X packet to the V2X layer when sending V2X
    packet.
      For unicast,
    The V2X application layer may provide PC5 QoS parameters or PC5 QoS
    requirements when providing application information for PC5 unicast
    communication to the V2X layer (step 2 of clause 6.3.3.1). Multiple sets of PC5
    QoS parameters or PC5 QoS requirements may be provided from the V2X
    application layer.
    The V2X application layer may provide PC5 QoS parameters or PC5 QoS
    requirements together with V2X packet to the V2X layer when sending V2X
    packet. In particular, if a PC5 unicast link includes multiple PC5 QoS Flows, the
    V2X application layer needs to provide PC5 QoS parameters or PC5 QoS
    requirements together with V2X packet to the V2X layer so that the V2X layer can
    determine which PC5 QoS Flow the V2X packet corresponds to.
    The V2X application layer may provide additional PC5 QoS parameters or PC5
    QoS requirements for the established PC5 unicast link.
    The V2X application layer may remove any PC5 QoS parameters or PC5 QoS
    requirements from the established PC5 unicast link by indicating this to the V2X
    layer.
Similar to other V2X parameters, ″PC5 QoS rules″ can be pre-configured in the UE, or, if in
coverage, provisioned or updated by signalling over the N1 reference point from the PCF in
the HPLMN or over V1 reference point from the V2X Application Server.
Proposal#6: It is proposed that ″PC5 QoS rules″ can be pre-configured in the UE, or,
if in coverage, provisioned or updated by signalling over the N1 reference point from
the PCF in the HPLMN or over V1 reference point from the V2X Application Server.
[2] PFI (PC5 QoS Flow Identifier)
For Uu communication, the QoS Flow is the finest granularity of QoS differentiation in the
PDU Session. For PC5 communication, we think that the PC5 QoS Flow is the finest
granularity of QoS differentiation in the same destination identified by Destination Layer-2
ID.
Proposal#7: It is proposed that for V2X communication over NR PC5, the PC5 QoS
Flow is the finest granularity of QoS differentiation in the same destination identified
by Destination Layer-2 ID.
User Plane traffic with the same PFI receives the same traffic forwarding treatment (e.g.
scheduling, admission threshold). The PFI is unique within a same destination. The UE
assigns PFI based on the PC5 QoS parameters derived or provided by V2X application
layer.
For unicast, the UE initiating PC5 unicast link establishment assigns PFI(s) such as 1, 2, 3
and etc, and provides the assigned PFI(s) to the peer UE by including the assigned PFI(s)
with the related PC5 QoS parameters in a Direct Communication Request message. In
addition, for the established PC5 unicast link, the UE initiating PC5 unicast link
modification to add some PC5 QoS Flow(s) assigns PFI(s) and provides the assigned PFI(s)
to the peer UE.
Proposal#8: It is proposed that the PFI is unique within a same destination. The UE
assigns PFI based on the PC5 QoS parameters derived or provided by V2X application
layer.
Proposal#9: It is proposed that for unicast, the UE initiating PC5 unicast link
establishment assigns PFI(s) such as 1, 2, 3 and etc, and provides the assigned PFI(s) to
the peer UE by including the assigned PFI(s) with the related PC5 QoS parameters in a
Direct Communication Request message.
```

```
TABLE 17
Proposal#10: It is proposed that for the established PC5 unicast link, the UE initiating
PC5 unicast link modification to add some PC5 QoS Flow(s) assigns PFI(s) and
provides the assigned PFI(s) to the peer UE.
When the UE assigns a new PFI, the UE stores it with the corresponding PC5 QoS
parameters in a context for the destination. When the UE releases the PFI, the UE removes it
from a context for the destination. The enables for the UE to determine whether V2X packet
from the V2X application layer corresponds to existing PFI. For unicast the Unicast Link
Profile defined in clause 5.2.1.4 can be used as a context to store PFI and the corresponding
PC5 QoS parameters.
Proposal#11: It is proposed that the UE maintains mapping of PFI to PC5 QoS
parameters in a context per destination.
[3] SLRB establishment/release
Regarding SLRB establishment, the followings are applied:
    The UE performs SLRB establishment when it decides new SLRB is needed to deliver
    PC5 QoS Flow(s).
    The UE establishes at least one SLRB for any destination and additional SLRB(s) for
    PC5 QoS flow(s) of that destination can be subsequently established.
    The UE maps V2X packets belonging to different destinations to different SLRBs.
Proposal#12: It is proposed that the UE establishes at least one SLRB for any
destination and additional SLRB(s) for PC5 QoS flow(s) of that destination can be
subsequently established.
The UE may perform SLRB release in the following cases:
    For broadcast, when the UE determines the SLRB is not needed anymore, e.g. based
    on information from the V2X application layer that the related service was stopped or
    completed resulting in removal of the corresponding PC5 QoS Flow(s) and PFI(s),
    when an implementation dependent inactivity timer for the SLRB expired.
    For groupcast, when the UE determines the SLRB is not needed anymore, e.g. based
    on information from the V2X application layer that the related group communication
    was over or stopped resulting in removal of the corresponding PC5 QoS Flow(s) and
    PFI(s), when an implementation dependent inactivity timer for the SLRB expired.
    For unicast, when the UE determines the SLRB is not needed anymore, e.g. when the
    PC5 unicast link was released, when the related PC5 QoS Flow(s) and PFI(s) were
    removed from the PC5 unicast link.
Proposal#13: It is proposed that the UE may perform SLRB release when the UE
determines the SLRB is not needed anymore.
[4] PC5-SDAP configuration
Several PC5-SDAP entities may be defined for a UE. A single entity of PC5-SDAP is
configured for each destination.
Proposal#14: It is proposed that several PC5-SDAP entities may be defined for a UE
and a single entity of PC5-SDAP is configured for each destination.
The UE performs PC5-SDAP (re)configuration as below:
    For a new PC5 QoS Flow, the UE adds mapping between the PC5 QoS Flow (i.e. PFI)
    and an SLRB to the corresponding PC5-SDAP entity. In this case, when there is no
    PC5-SDAP entity, the UE first establishes a PC5-SDAP entity.
```

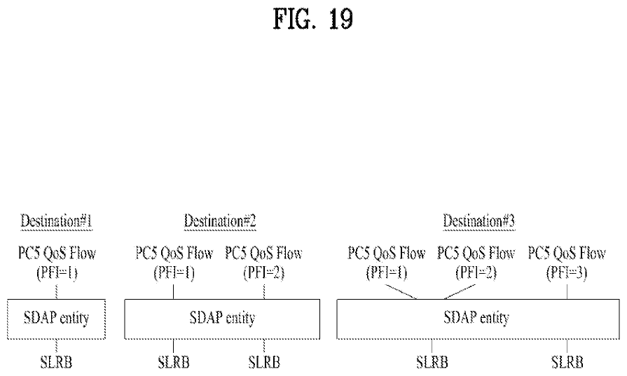

```
TABLE 18
    For a removed PC5 QoS Flow, the UE deletes mapping between the PC5 QoS Flow
(i.e. PFI) and an SERB from the corresponding PC5-SDAP entity. In this case, the UE
releases the PC5-SDAP entity when no mapping is left in the PC5-SDAP entity.
Proposal#15: It is proposed that the UE performs PC5-SDAP (re)configuration for a
new PC5 QoS Flow and for a removed PC5 QoS Flow.
FIG. 19: An example mapping between PC5 QoS Flow and SLRB
----------------
[1] to [4] explained above and all proposals are applied to Mode 1 and Mode 2.
2. Proposal
It is proposed to agree the following changes into TS 23.287.
* * * * Start of Changes * * * *
5.4.1 QoS handling for V2X communication over PC5 reference point
5.4.1.1 QoS model
5.4.1.1.1 General overview
For LTE based PC5, the QoS handling is defined in TS 23.285 [8], based on ProSe Per-
Packet Priority (PPPP) and ProSe Per-Packet Reliability (PPPR).
For NR based PC5, a QoS model similar to that defined in TS 23.501 [6] for Uu reference
point is used, i.e. based on 5QIs, with additional parameter of Range. For the V2X
communication over NR based PC5 reference point, a PC5 QoS Flow is associated with a
PC5 QoS rule that contains the PC5 QoS parameters as defined in clause 5.4.2. A set of
standardized PC5 5QIs (PQI) are defined in clause 5.4.4. The UE may be configured with a
set of default PC5 QoS parameters to use for the V2X services, as defined in clause 5.1.2.1.
For NR based unicast, groupcast and broadcast PC5 communication, Per-flow QoS model
for PC5 QoS management shall be applied. Figure 5.4.1.1.1-1 illustrates an example
mapping of Per-flow QoS model for NR PC5. Details of PC5 QoS rules and PFI related
operations are described in clause 5.4.1.1.2 while PC5-SDAP sublayer and mapping
between PC5 QoS Flow and SideLink Radio Bearer (SLRB) are described in
clause 5.4.1.1.3.
FIG. 8: Per-Flow PC5 QoS Model for NR PC5
The following principles apply when the V2X communication is carried over PC5 reference
point:
    Application layer may set the QoS requirements for the V2X communication, using
either TS 23.285 [8] defined PPPP and PPPR model or the PQI and Range model. Depends
on the type of PC5 reference point, i.e. LTE based or NR based, selected for the
transmission, the UE may map the application layer provided QoS requirements to the
suitable QoS parameters to be passed to the lower layer. The mapping between the two QoS
models is defined in clause 5.4.2.
```

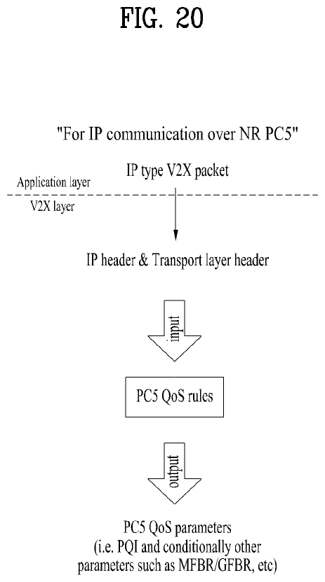

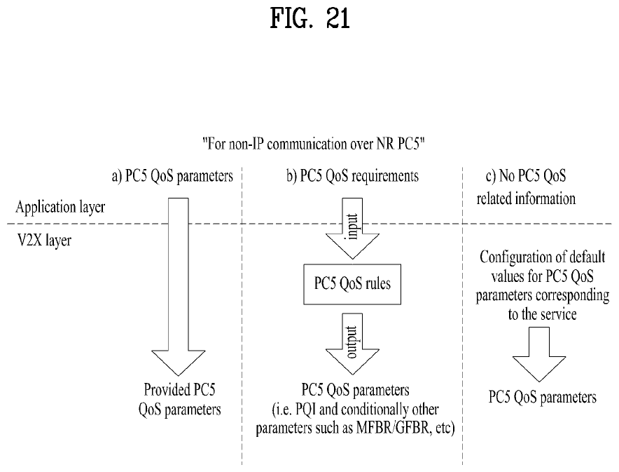

```
TABLE 19
      When groupcast or unicast mode of V2X communication over NR based PC5
    is used, a Range parameter is associated with the QoS parameters for the V2X
    communication. The Range may be provided by V2X application layer or use a
    default value mapped from the service type based on configuration as defined in
    clause 5.1.2.1. The Range indicates the minimum distance that the QoS
    parameters need to be fulfilled. The Range parameter is passed to AS layer
    together with the QoS parameters for dynamic control.
      NR based PC5 supports three types of communication mode, i.e. broadcast,
    groupcast, and unicast. The QoS handling of these different modes are described
    in clauses 5.4.1.2 to 5.4.1.4.
      The UE may handle broadcast, groupcast, and unicast traffic by taking all
    their priorities, e.g. indicated by PQIs, into account.
      For broadcast and groupcast modes of V2X communication over NR based
    PC5, standardized PQI values are applied by the UE, as there is no signalling over
    PC5 reference point for these cases.
      When network scheduled operation mode is used, the UE-PC5-AMBR for
    NR based PC5 applies to all types of communication modes, and is used by NG-
    RAN for capping the UE's NR based PC5 transmission in the resources
    management.
Editor's note: The support of new QoS model, including PQI and Range, depends on RAN
WGs' feedback.
5.4.1.1.2 PC5 QoS rule and PFI
The following description applies to for both network scheduled operation mode and UE
autonomous resources selection mode.
For NR PC5 QoS mechanisms, ″PC5 QoS rules″ is defined to derive PC5 QoS parameters
defined in clause 5.4.2 (i. e. PQI and conditionally other parameters such as MFBR/GFBR,
etc). PFI is not derived from PC5 QoS rules and assigned by the UE.
For IP communication over NR PC5 reference point, similar to IP communication over Uu
reference point, packet filter information can be used as input to derive PC5 QoS
parameters. This means that when V2X application layer sends IP type V2X packet, V2X
layer derives PC5 QoS parameters for the V2X packet based on PC5 QoS rules by using
information of IP header and transport layer header as packet filter, i.e. input.
FIG. 20 shows how PC5 QoS parameters are derived for IP communication over NR PC5.
FIG. 20: Deriving PC5 QoS parameters for IP communication over NR PC5
For non-IP communication over NR PC5 reference point, the following operations to derive
PC5 QoS parameters are applied:
    a) When V2X application layer provides PC5 QoS parameters (i.e. PQI and
    conditionally other parameters) to V2X layer, the V2X layer uses the provided
    PC5 QoS parameters;
    b) When V2X application layer provides PC5 QoS requirements, e.g. priority
    requirement, reliability requirement, delay requirement, to V2X layer, the V2X
    layer derives PC5 QoS parameters based on PC5 QoS rules by using the provided
    PC5 QoS requirements as input;
    c) Otherwise, i.e. when V2X application layer does not provide any PC5 QoS
    related information to V2X layer, the V2X layer uses default values for PC5 QoS
    parameters corresponding to the service (e.g. PSID/ITS-AID).
FIG. 21 shows how PC5 QoS parameters are derived for non-IP communication over NR
PC5.
FIG. 21: Deriving PC5 QoS parameters for non-IP communication over NR PC5
Regarding a) and b) for non-IP communication over NR PC5 reference point, the followings
are assumed regarding when the V2X application layer provides PC5 QoS parameters or
PC5 QoS requirements to the V2X layer.
      For broadcast,
```

```
TABLE 20
    The V2X application layer provides PC5 QoS parameters or PC5 QoS
    requirements together with V2X packet to the V2X layer whenever sending the
    V2X packet.
      For groupcast,
    The V2X application layer may provide PC5 QoS parameters or PC5 QoS
    requirements when providing group identifier information (i .e. an Application-layer
    V2X Group identifier) to the V2X layer (step 2 of clause 6.3.2).
    The V2X application layer may provide PC5 QoS parameters or PC5 QoS
    requirements together with V2X packet to the V2X layer when sending V2X
    packet.
      For unicast,
    The V2X application layer may provide PC5 QoS parameters or PC5 QoS
    requirements when providing application information for PC5 unicast
    communication to the V2X layer (step 2 of clause 6.3.3.1), Multiple sets of PC5
    QoS parameters or PC5 QoS requirements may be provided from the V2X
    application layer.
    The V2X application layer may provide PC5 QoS parameters or PC5 QoS
    requirements together with V2X packet to the V2X layer when sending V2X
    packet. In particular, if a PC5 unicast link includes multiple PC5 QoS Flows, the
    V2X application layer needs to provide PC5 QoS parameters or PC5 QoS
    requirements together with V2X packet to the V2X layer so that the V2X layer can
    determine which PC5 QoS Flow the V2X packet corresponds to.
    The V2X application layer may provide additional PC5 QoS parameters or PC5
    QoS requirements for the established PC5 unicast link.
    The V2X application layer may remove any PC5 QoS parameters or PC5 QoS
    requirements from the established PC5 unicast link by indicating this to the V2X
    layer.
PC5 QoS rules can be pre-configured in the UE, or, if in coverage, provisioned or updated
bv signalling over the N1 reference point from the PCF in the HPLMN or over V1 reference
point from the V2X Application Server.
For V2X communication over NR PC5 reference point, the PC5 QoS Flow is the finest
granularity of QoS differentiation in the same destination identified by Destination Laver-2
ID. User Plane traffic with the same PFI receives the same traffic forwarding treatment (e.g.
scheduling, admission threshold). The PFI is unique within a same destination. The UE
assigns PFI based on the PC5 QoS parameters derived or provided by V2X application
layer.
For unicast, the UE initiating PC5 unicast link establishment assigns PFI(s) such as 1, 2, 3
and etc, and provides the assigned PFI(s) to the peer UE by including the assigned PFI(s)
with the related PC5 QoS parameters in a Direct Communication Request message. In
addition, for the established PC5 unicast link, the UE initiating PC5 unicast link
modification to add some PC5 QoS Flow(s) assigns PFI(s) and provides the assigned PFI(s)
to the peer UE.
A UE may configure/assign a PFI to be equal to a PQI value.
Unlike the above description, a PFI may be uniquely assigned within a UE irrespective of
destination. Or, a PFI may be uniquely assigned within the same communication mode type,
i.e., broadcast, groupcast or unicast.
In unicast, in case that a plurality of services (e.g., services identified by PSID or ITS-AID)
use the same unicast link, although the samePC5 QoS parameters are derived for the
different services, a UE may need to generate a different PFI for each of the services.
Namely, as the PC5 QoS parameters are identical for the different services, when a packet is
actually transmitted via a unicast link, a UE having received the packet may not be able to
identify that the received packet is associated with which service.
The UE maintains mapping of PFI to PC5 QoS parameters in a context per destination.
When the UE assigns a new PFI, the UE stores it with the corresponding PC5 QoS
parameters in the context for the destination. When the UE releases the PFI, the UE removes
it from the context for the destination. The enables for the UE to determine whether V2X
packet from the V2X application layer corresponds to existing PFI. For unicast, the Unicast
Link Profile defined in clause 5.2.1.4 can be used as a context to store PFI and the
corresponding PC5 QoS parameters.
In the above description, when a new PFI is assigned and saved in the context together with
the corresponding PC5 QoS parameters, an associated service information may need to be
stored as well. This may apply to unicast only or all the unicast/groupcast/broadcast.
```

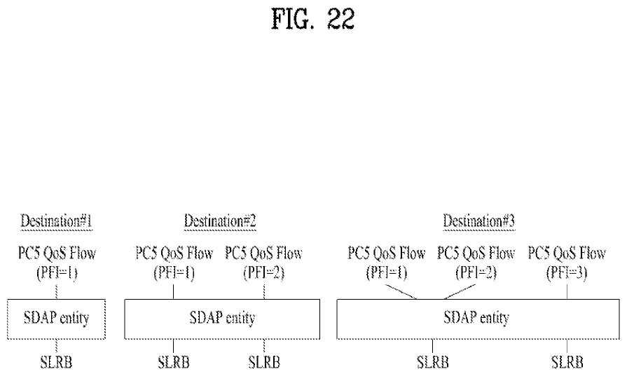

TABLE 21
5.4.1.1.3 PC5-SDAP sublayer and Mapping between PC5 QoS Flow and SideLink
Radio Bearer (SLRB)
The following description applies to for both network scheduled operation mode and UE
autonomous resources selection mode.
Regarding SideLink Radio Bearer (SLRB) establishment, the followings are applied:
The UE performs SLRB establishment when it decides new SLRB is needed
to deliver PC5 QoS Flow(s).
The UE establishes at least one SLRB for any destination and additional
SLRB(s) for PC5 QoS flow(s) of that destination can be subsequently established.
The UE maps V2X packets belonging to different destinations to different
SLRBs.
The UE may perform SLRB release in the following cases:
For broadcast, when the UE determines the SLRB is not needed anymore,
e.g. based on information from the V2X application layer that the related service
was stopped or completed resulting in removal of the corresponding PC5 QoS
Flow(s) and PFI(s), when an implementation dependent inactivity timer for the
SLRB expired.
For groupcast, when the UE determines the SLRB is not needed anymore,
e.g. based on information from the V2X application layer that the related group
communication was over or stopped resulting in removal of the corresponding
PC5 QoS Flow(s) and PFI(s), when an implementation dependent inactivity timer
for the SLRB expired.
For unicast, when the UE determines the SLRB is not needed anymore, e.g.
when the PC5 unicast link was released, when the related PC5 QoS Flow(s) and
PFI(s) were removed from the PC5 unicast link.
Several PC5-SDAP entities may be defined for a UE. A single entity of PC5-SDAP is
configured for each destination.
The UE performs PC5-SDAP (re)configuration as below:
For a new PC5 QoS Flow, the UE adds mapping between the PC5 QoS Flow
fi.e. PFI) and an SLRB to the corresponding PC5-SDAP entity. In this case, when
there is no PC5-SDAP entity, the UE first establishes a PC5-SDAP entity.
For a removed PC5 QoS Flow, the UE deletes mapping between the PC5
QoS Flow (i.e. PFI) and an SLRB from the corresponding PC5-SDAP entity. In
this case, the UE releases the PC5-SDAP entity when no mapping is left in the
PC5-SDAP entity.
FIG. 22 shows an example mapping between PC5 QoS Flow and SLRB.
FIG. 22: An example mapping between PC5 QoS Flow and SLRB
The SLRB management and PC5-SDAP (re)configuration may be performed in a PC5-RRC
layer.
In case of unicast, PC5-SDAP configuration information and/or SLRB information of an
initiating UE may be provided to a counter UE. This may occur in case of unicast link
generation, unicast link modification (for PC5 QoS Flow addition or removal, QoS parameter
modification of PC5 QoS Flow, etc.) and the like. This may use a PC5-RRC message.
Alternatively, a PC5-S message may be used or both of the messages may be used. The
initiating UE may mean a UE initiating addition of PC5 QoS Flow, a UE initiating removal of
PC5 QoS Flow, a UE initiating modification of QoS parameter of PC5 QoS Flow, a UE
initiating unicast link generation, or a UE initiating unicast link modification.

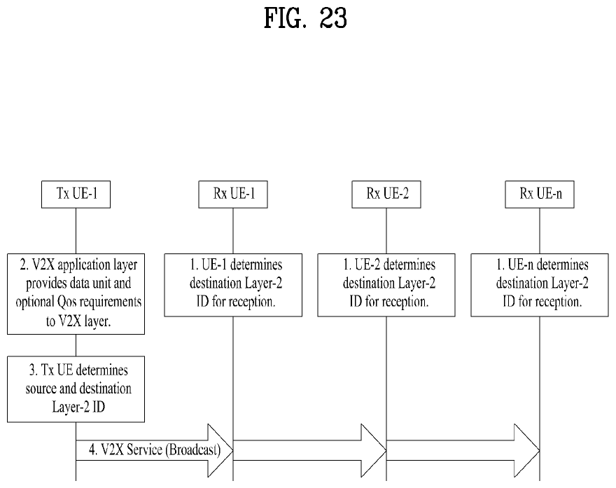

TABLE 22
Regarding how a UE can map a multitude of PC5 QoS Flows to one SLRB (this can be
construed as a multitude of PC5 QoS Flows share SLRB), a corresponding reference may be
configured in a UE or provided by a network (NG-RAN or core network entity (e.g., PCF,
etc.)). In case of the provision by the network, the NG-RAN may use an SIB or a dedicated
signal and a core network may use an NAS message. The reference may include a list of
PQIs that can share SLRB together. Instead, the reference may include a list of priority
levels capable of sharing SLRB together, a list of PDB values capable of sharing SLRB
together, a list of PER values capable of sharing SLRB together, etc. Alternatively,
information on the reference may be configured in a manner of combining them together.
As described above, the UE directly performs PC5-SDAP configuration and SLRB
management, which may apply to UE autonomous resources selection mode only. Or, it
may apply to a case that the UE operates in idle mode or out of network coverage only.
* * * * End of Changes * * * *
2. Proposal
It is proposed to agree the following changes into TS 23.287.
* * * * Start of Changes * * * *
6.3.1 Broadcast mode V2X communication over PC5 reference point
To perform V2X communication over PC5 reference point in broadcast mode operation, the
UE is configured with the related information as described in clause 5.1.2.
FIG. 23 shows the procedure for broadcast mode of V2X communication over PC5
reference point.
FIG. 23: Procedure for Broadcast mode of V2X communication over PC5 reference
point
1. The receiving UE(s) determine the destination Layer-2 ID for broadcast reception as
specified in clause 5.6.1.2. The destination Layer-2 ID is passed down to the AS layer
of receiving UE(s) for the reception.
2. The transmitting UE V2X application layer provides data unit, and may provide PC5
QoS requirements or PC5 QoS parameters specified in clause 5.4.1.1 to V2X layer.
3. The transmitting UE determines the destination Layer-2 ID for broadcast as specified
in clause 5.6.1.2. The transmitting UE self-assigns the source Layer-2 ID as specified
in clause 5.6.1.1.
The transmitting UE determines the PC5 QoS parameters for this broadcast V2X
service as specified in clauses 5.4.1.1 and 5.4.1.2.
4. When providing an AS layer with V2X service data (construed as a V2X packet, a
V2X message, etc.) to transmit, a V2X layer of a transmitting UE may provide the AS
layer with a PFI value associated with the data as well. Based on the PFI value, the AS
layer may determine whether to transmit the V2X service data using which SLRB.
The transmitting UE sends the V2X service data using the source Layer-2 ID and the
destination Layer-2 ID.

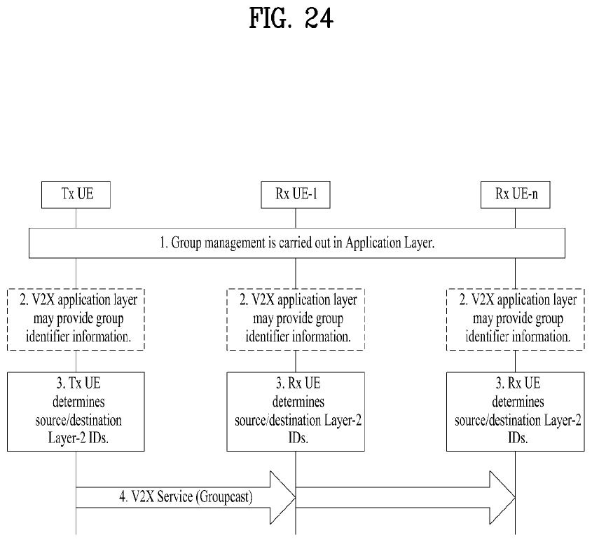

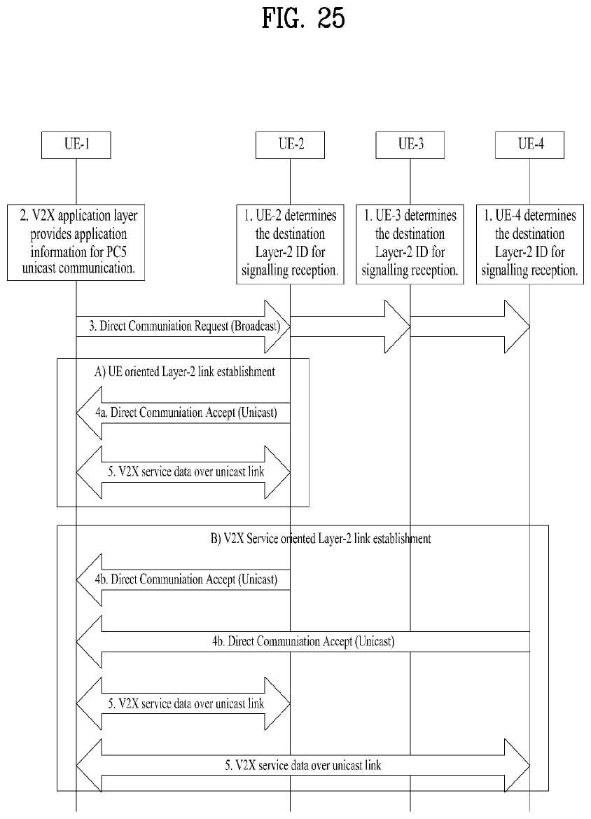

TABLE 23
NOTE: In step 4, there is only one broadcast message from the transmitting UE.
* * * * Start of Next Change * * * *
6.3.2 Groupcast mode V2X communication over PC5 reference point
To perform groupcast mode of V2X communication over PC5 reference point, the UE is
configured with the related information as described in clause 5.1.2.1.
FIG. 24 shows the procedure for groupcast mode of V2X communication over PC5
reference point.
FIG. 24: Procedure for groupcast mode of V2X communication over PC5 reference
point
1. V2X group management is carried out by the V2X application layer and is out of
scope of this specification.
2. The V2X application layer may provide group identifier information (i.e. an
Application-layer V2X Group identifier) as specified in clause 5.6.1.3.
The V2X application layer may provide PC5 QoS requirements or PC5 QoS
parameters for this communication.
3. Transmitting UE determines a source Layer-2 ID and a destination Layer-2 ID and
Receiving UE(s) determine destination Layer-2 ID, as specified in clauses 5.6.1.1 and
5.6.1.3.
The destination Layer-2 ID is passed down to the AS layer of Receiving UE(s) for the
group communication reception.
Transmitting UE determines the PC5 QoS parameters for this groupcast as specified in
clauses 5.4.1.1 and 5.4.1.3.
4. Transmitting UE has a V2X service associated with this group communication.
When providing an AS layer with V2X service data (construed as a V2X packet, a
V2X message, etc.) to transmit, a V2X layer of a transmitting UE may provide the AS
layer with a PFI value associated with the data as well. The AS layer may mean a
PC5-SDAP layer. Based on the PFI value, the AS layer may determine whether to
transmit the V2X service data using which SLRB.
Transmitting UE sends the V2X service data using the source Layer-2 ID and the
destination Layer-2 ID.
NOTE: In step 4, there is only one groupcast message from the transmitting UE
Editor's note: Whether the groupcast communication require security protection at link
layer will be determined based on feedback from SA WG3.
* * * * Start of Next Change * * * *
6.3.3 Unicast mode V2X communication over PC5 reference point
6.3.3.1 Layer-2 link establishment over PC5 reference point
To perform unicast mode of V2X communication over PC5 reference point, the UE is
configured with the related information as described in clause 5.1.2.1.
FIG. 25 shows the layer-2 link establishment procedure for unicast mode of V2X
communication over PC5 reference point.
FIG. 25: Layer-2 link establishment procedure

TABLE 24
1. The UE(s) determine the destination Layer-2 ID for signalling reception for PC5
unicast link establishment as specified in clause 5.6.1.4. The destination Layer-2 ID is
configured with the UE(s) as specified in clause 5.1.2.1.
2. The V2X application layer in UE-1 provides application information for PC5 unicast
communication. The application information includes the service type (e.g. PSID or
ITS-AID) of the V2X application. The initiating UE's application layer ID and the
target UE's application layer ID may be included in the application information.
The V2X application layer may provide PC5 QoS requirements or PC5 QoS
parameters for this unicast communication. UE-1 determines the PC5 QoS parameters
for this unicast as specified in clauses 5.4.1.1 and 5.4.1.4.
Editor's Note: It is FFS whether same PC5 unicast link can be established for more than
one service types (e.g. PSIDs or ITS-AIDs).
3. UE-1 sends a Direct Communication Request message to initiate the unicast layer-2
link establishment procedure. The Direct Communication Request message includes:
If the V2X application layer provided the target UE's application layer ID in step 2,
the following information is included:
User Info: the target UE's application layer ID (i.e. UE-2's application layer ID),
besides the initiating UE's application layer ID (i.e. UE-1's application layer ID).
Editor's Note: It is left to Stage 3 to decide if these IDs can be carried in the same IE or
separate IEs, for example, the Station ID/Vehicle Temp ID only needs to be 4
octets.
V2X Service Info: the information about V2X Service requesting Layer-2 link
establishment (e.g. PSID or ITS-AIDs).
Indication whether IP communication is used.
IP Address Configuration: For IP communication, IP address configuration is
required for this link.
Editor's Note: Detail of IP Address Configuration is FFS.
QoS Info: the information about PC5 QoS Flow(s). For each PC5 QoS Flow, the
PFI and the corresponding PC5 QoS parameters (i.e. PQI and conditionally other
parameters such as MFBR/GFBR, etc). Additionally, service information (this may
be the service type (e.g. PSID or ITS-AID)) may need to be included in each PC5
QoS Flow. In a manner of configuring an information element to include
information on PC5 QoS Flow(s) for each service, service information associated
with each PC5 QoS Flow may be provided to a counter UE. The PC5 QoS
parameters information may be included or not. If such information is included,
PQI information may be included only instead of all parameters. In addition,
Application Layer ID information (e.g., source Application Layer ID and/or
destination Application Layer ID) associated with PC5 QoS Flow or a service of
the PC5 QoS Flow may be included.
The source Layer-2 ID and destination Layer-2 ID used to send the Direct
Communication Request message are determined as specified in clauses 5.6.1.1 and
5.6.1.4.
UE-1 sends the Direct Communication Request message via PC5 broadcast using the
source Layer-2 ID and the destination Layer-2 ID.
4. A Direct Communication Accept message is sent to UE-1 as below:
4a. (UE oriented Layer-2 link establishment) If the User Info is included in the
Direct Communication Request message, the target UE, i.e. UE-2 responds with a
Direct Communication Accept message.
4b. (V2X Service oriented Layer-2 link establishment) If the User Info is not
included in the Direct Communication Request message, the UEs that are interested
in using the announced V2X Service respond to the request by sending a Direct
Communication Accept message (UE-2 and UE-4 in FIG. 6.3.3.1-1).

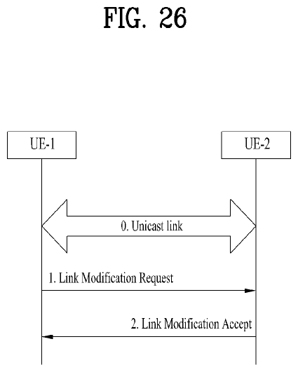

TABLE 25
The source Layer-2 ID used to send the Direct Communication Accept message is
determined as specified in clauses 5.6.1.1 and 5.6.1.4. The destination Layer-2 ID is set
to the source Layer-2 ID of the received Direct Communication Request message.
In case of responding with Direct Communication Accept message, accept, reject or
other values may be provided for QoS Info included in Direction Communication
Request message. For example, if PQI = 3, MFBR = aa, and GFBR = bb are included in
QoS Info of Direction Communication Request message with respect to PFI = 1, a UE
may include PQI = 3, MFBR = aa, GFBR = cc in Direction Communication Accept
message with respect to PFI = 1. Having received such a message, a UE-1 may accept it
and transmit a message indicating acceptance to a counter UE. In case of accepting it,
the UE may not transmit a message additionally. Only if rejecting it, the UE may
transmit a message indicating rejection to the counter UE. Thus, in case of rejecting
specific PC5 QoS Flow, a unicast link may not be established. And, a unicast link may
be established for another accepted PC5 QoS Flow (if existing) only.
Upon receiving the Direct Communication Accept message from peer UE, UE-1 obtains
the peer UE's Layer-2 ID for future communication, for signalling and data traffic for
this unicast link.
5. V2X service data is transmitted over the established unicast link as below:
UE-1 has a V2X service associated with this unicast link.
The communication mode (i.e. unicast), and Layer-2 ID information (i.e. source Layer-2
ID and destination Layer-2 ID) are provided to the AS layer, together with the V2X
message.
When providing an AS layer with V2X service data (construed as a V2X packet, a V2X
message, etc.) to transmit, a V2X layer of a transmitting UE may provide the AS layer
with a PFI value associated with the data as well. The AS layer may mean a PC5-SDAP
layer. Based on the PFI value, the AS layer may determine whether to transmit the V2X
service data using which SLRB.
UE-1 sends the V2X service data using the source Layer-2 ID (i.e. UE-1's Layer-2 ID
for this unicast link) and the destination Layer-2 ID (i.e. UE-2's Layer-2 ID for this
unicast link).
Editor's Note: It is FFS whether the information such as communication mode, source
Layer-2 ID, destination Layer-2 ID provided to the AS layer is needed all the
time when the UE sends V2X message or only the time when the unicast lilnk
established and Layer-2 ID is changed.
NOTE: PC5 unicast link is bi-directional, therefore the peer UE of UE-1 can
send the V2X service data to UE-1 over the unicast link with UE-1.
Editor's Note: The parameters included in the Direct Communication Request/Accept
messages can be updated depending on RAN WGs' decision on how the Direct
Communication Request/Accept messages are sent by the AS layer (e.g. by
using PC5-RRC signalling).
Editor's Note: Additional parameters included in the Direct Communication
Request/Accept messages (e.g. security related) are FFS.
Editor's Note: Whether the unicast communication requires security protection at link
layer will be determined based on feedback from SA WG3.
* * * * End of Changes * * * *
6.3.3.x Layer-2 link modification for a unicast link
FIG. 26 shows the layer-2 link modification procedure for a unicast link. This procedure is
used to:

TABLE 26
add new service(s) to the existing PC5 unicast link.
remove any service(s) from the existing PC5 unicast link.
add new PC5 QoS Flow(s) to the existing PC5 unicast link.
remove any PC5 QoS Flow(s) from the existing PC5 unicast link.
Modify PC5 QoS parameters of prescribed PC5 QoS Flow(s) in an existing PC5
unicast link.
FIG. 26: Layer-2 link modification procedure
0. UE-1 and UE-2 have a unicast link established as described in clause 6.3.3.1.
1. The V2X application layer in UE-1 provides application information for PC5 unicast
communication. The application information includes the service type(s) (e.g. PSID or
ITS-AID) of the V2X application(s) and the initiating UE's application layer ID. The
target UE's application layer ID may be included in the application information. If there
exists a PC5 unicast link for a same pair of the initiating UE's application layer ID and
the target UE's application layer ID, UE-1 decides to modify the unicast link established
with UE-2 and sends a Link Modification Request to UE-2.
QoS related information may be included in Link Modification Request message. This
may refer to QoS Info contents included in Direct Communication Request message of
FIG. 6.3.3.1-1: Layer-2 link establishment procedure of <2> in case of adding new
PC5 QoS Flow. In case of removing PC5 QoS Flow, a PFI indicating PC5 QoS Flow to
remove may be included..
2. UE-2 responds with a Link Modification Accept message.
QoS related information may be included in Link Modification Accept message. This
may refer to QoS Info contents included in Direct Communication Accept message of
FIG. 6.3.3.1-1: Layer-2 link establishment procedure of <2> in case of adding new
PC5 QoS Flow. In case of removing PC5 QoS Flow, whether to accept it may be
included.
Editor's Note: The parameters included in the Link Modification Request/Accept
messages are FFS.
5.4.1.1.2PC5 QoS rule and PFI
The following description applies to for both network scheduled operation mode and UE
autonomous resources selection mode.
For NR PC5 QoS mechanisms, “PC5 QoS rules” is defined to derive PC5 QoS parameters
defined in clause 5.4.2 (i.e. PQI and conditionally other parameters such as MFBR/GFBR,
etc). PFI is assigned by the UE.
The following operations are applied to derive PC5 QoS parameters:
a) When V2X application layer provides service requirements for the V2X services, e.g.
priority requirement, reliability requirement, delay requirement, to V2X layer, the
V2X layer derives from the service requirements to PC5 QoS parameters based on
PC5 QoS rules; [symbol] V2X layer uses the derived PC5 QoS parameters for the V2X
service [symbol] V2X layer uses higher one between the derived PC5 QoS parameters for
the V2X service and the authorized PC5 QoS parameters for the V2X service.
b) Otherwise, i.e. when V2X application layer does not provide any information about
service requirements for the V2X services to V2X layer, the V2X layer uses the
authorized PC5 QoS parameters corresponding to the V2X service based on the
mapping between V2X services types (e.g. PSID/ITS-AID) and authorized PC5 QoS
parameters as defined in clause 5.1.2.1.

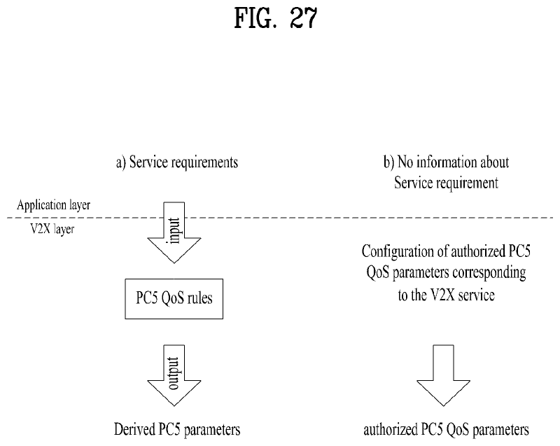

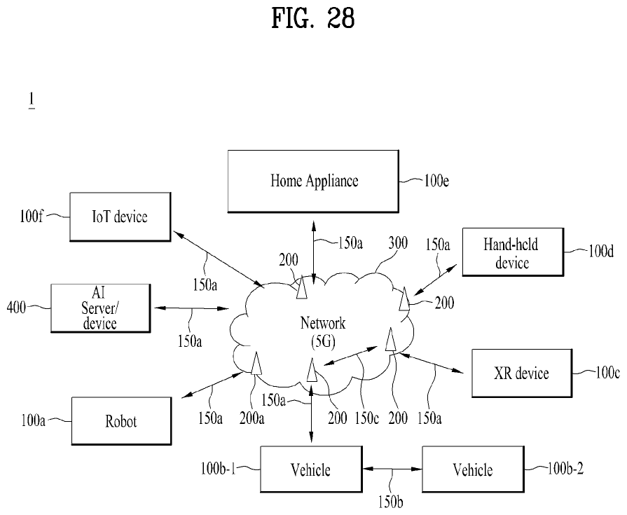

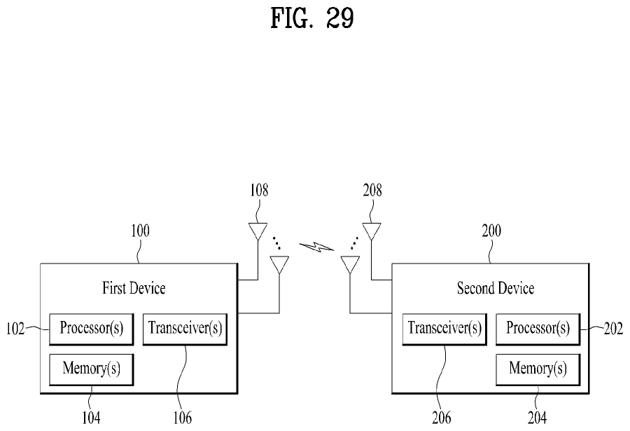

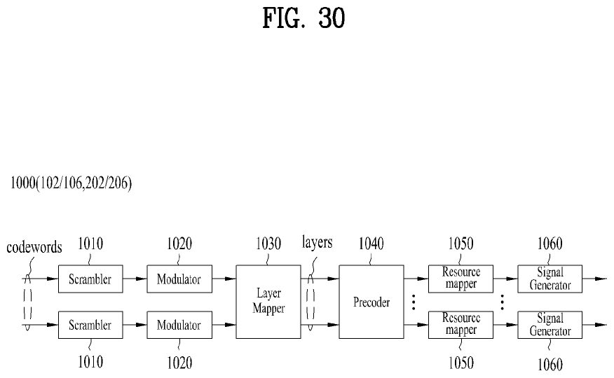

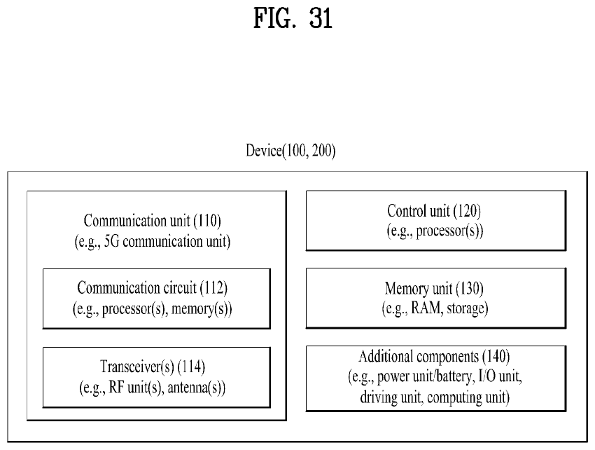

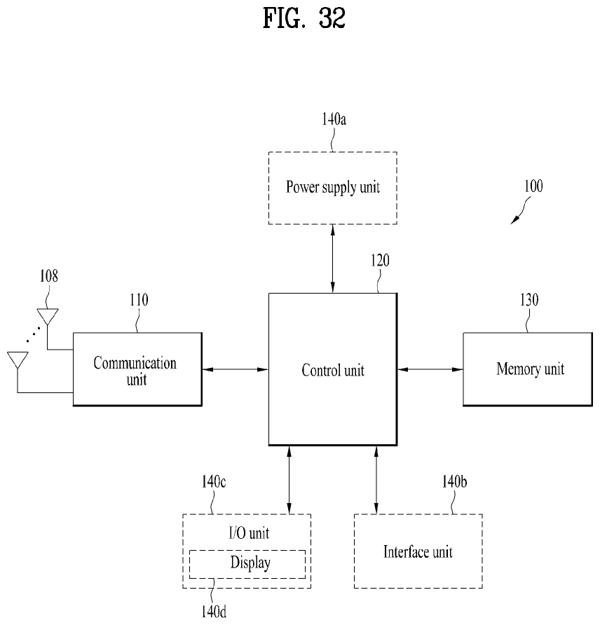

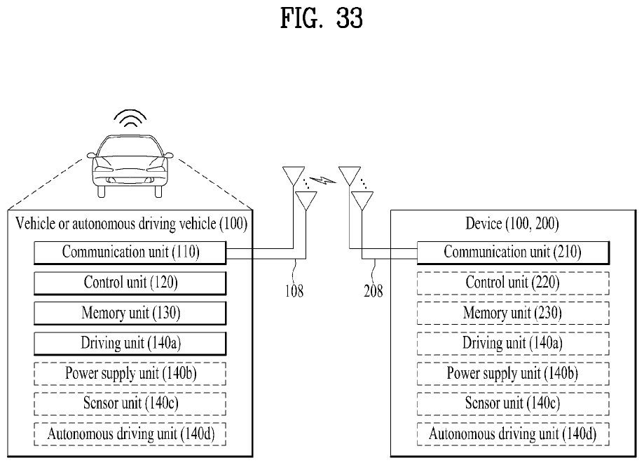

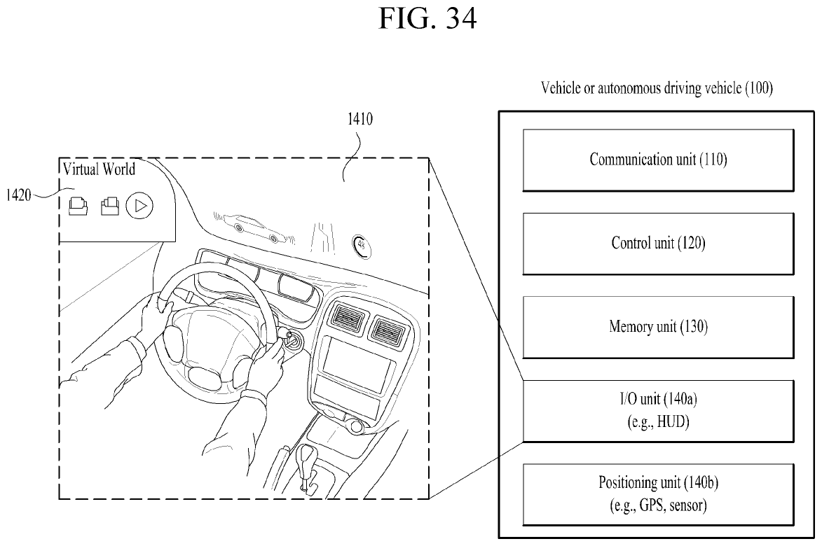

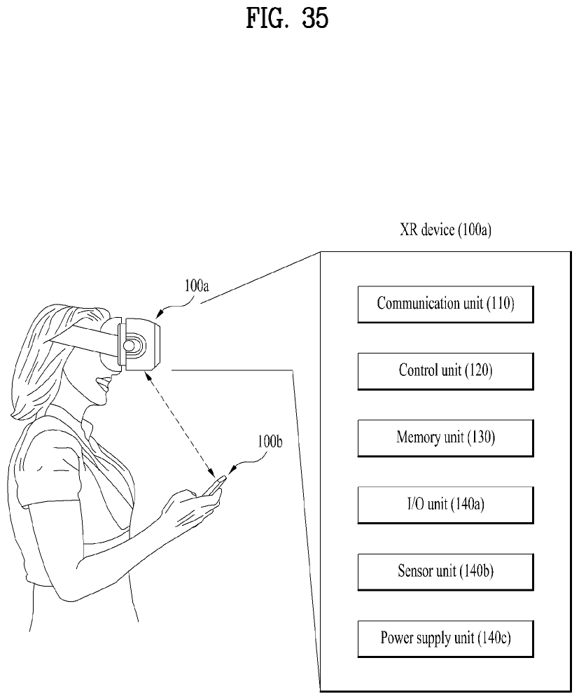

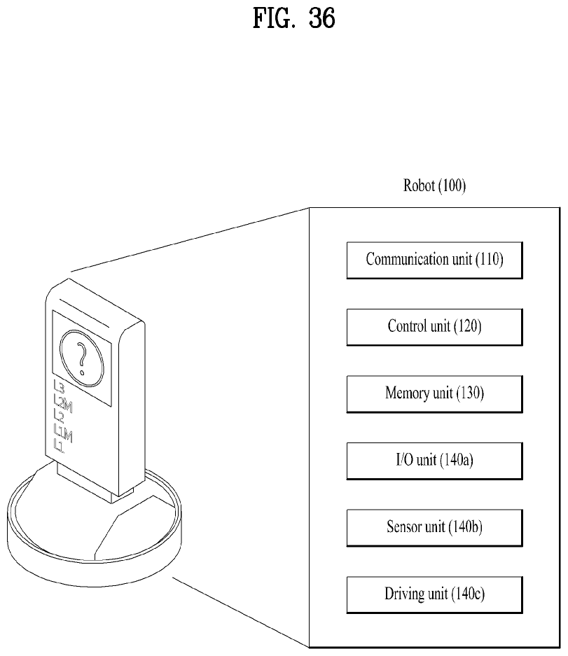

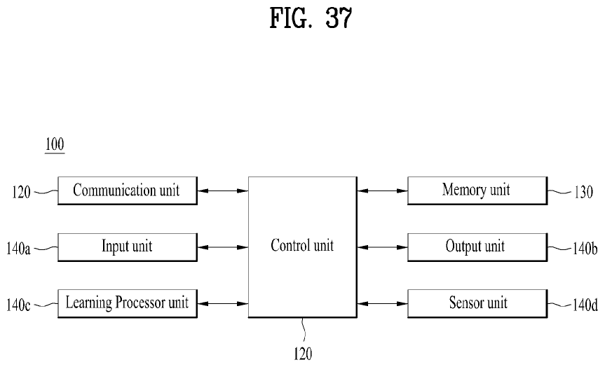

TABLE 27
Editor's note: It is FFS whether other operations need to be defined for IP communication
over NR PC5 to derive PC5 QoS parameters (e.g. other input than service
requirements). [symbol]
27 illustrates how PC5 QoS parameters are derived for V2X communication over NR
PC5.
FIG. 27: Deriving PC5 QoS parameters for V2X communication over NR
PC5
For V2X communication over NR PC5 reference point, the PC5 QoS Flow is the finest
granularity of QoS differentiation in the same destination identified by Destination Layer-2
ID. User Plane traffic with the same PFI receives the same traffic forwarding treatment (e.g.
scheduling, admission threshold). The PFI is unique within a same destination. The UE
assigns PFI based on the PC5 QoS parameters derived for V2X service.
Editor's note: It is FFS whether PFI and the corresponding PC5 QoS parameters need to
be exchanged over PC5-S messages between two UEs for unicast link.
The UE maintains mapping of PFI to PC5 QoS parameters and the V2X service in a context
per destination identified by Destination Layer-2 ID. When the UE assigns a new PFI for
V2X service, the UE stores it with the corresponding PC5 QoS parameters and the V2X
service (e.g. PSID or ITS-AID) in the context for the destination. When the UE releases the
PFI, the UE removes it from the context for the destination. The enables for the UE to
determine whether PFI for the V2X packet for any V2X service from the V2X application
layer exists already or new PFI needs to be assigned for the V2X packet. For unicast, the
Unicast Link Profile defined in clause 5.2.1.4 can be used as a context to store the PFI
information. In the above description, the V2X service information may be saved to a
context together with a PFI only if unicast, or may be saved for broadcast/groupcast/unicast
all.
1. Discussion
In the previous meeting, PC5 QoS rule and PFI related operations for NR PC5 were
discussed and captured in clause 5.4.1.1.2 (PC5 QoS rule and PFI) of TS 23.287. At that
time, the group did not discuss PC5-SDAP configuration and SLRB (Sidelink Radio Bearer)
management proposed by S2-1905480 in detail because RAN WGs have more
responsibility on these aspects.
However, there are some Editor's Notes about PC5 QoS parameters and the QoS handling
for network scheduled operation mode in TS 23.287 as below. Therefore, from procedural
perspective it would be good to discuss high-level operations and principles for NR PC5
QoS handling for network scheduled operation mode in SA2 and communicate with RAN
WGs if any agreement is made in SA2.
4.4.2 PCF: Detail of provisioning PC5 QoS parameters is FFS.
6.5.7 Delivery of PC5 QoS parameters to NG-RAN: What PC5 QoS parameters are sent
from PCF to AMF is FFS.
5.5 Subscription to V2X services: Other subscription information (e.g. PC5 QoS related) is
FFS.
5.1.2.1 Policy/Parameter provisioning: Regarding Policy/parameters provisioned to the UE
related to QoS for NR PC5 network scheduled operation mode, coordination with RAN
WGs is needed.
5.4.1.2 QoS handling for broadcast mode V2X communication over PC5 reference point:
The QoS handling for network scheduled operation mode is FFS.
For network scheduled operation mode, we propose for NG-RAN to provide PC5-SDAP
configuration and SLRB setup information to the UE.
Proposal 1: For network scheduled operation mode, it is proposed that NG-RAN
provides PC5-SDAP configuration and SLRB setup information to the UE.

TABLE 28
In order to get the NG-RAN perform SLRB setup and PC5-SDAP configuration for the UE,
the following information is considered necessary for the NG-RAN similar to QoS profile
provided from the SMF for Uu communication.
For each PC5 QoS Flow,
PFI
PQT
(Optional) Priority Level, Averaging Window, Maximum Data Burst Volume
For GBR PC5 QoS Flow: MFBR, GFBR
The MFBR and GFBR may be included in a manner of being sorted by uplink and
downlink.
According to clause 5.4.1.1.2 (PC5 QoS rule and PFI), the UE assigns PFI based on the PC5
QoS parameters such as PQT and etc., derived for V2X service. This applies to both network
scheduled operation mode and UE autonomous resources selection mode.
Therefore, the UE can provide the above information called “PC5 QoS profile” with
destination information, i.e. Destination Layer-2 ID associated with the above information
to the NG-RAN by using SidelinkUEInformation message. However, a message other than
SidelinkUEInformation message may be used.
Proposal 2: It is proposed that the UE provides “PC5 OoS profile” with destination
information, i.e. Destination Layer-2 ID associated with the PC5 QoS profile to the
NG-RAN by using SidelinkUEInformation message.
Based on the PC5 QoS profile, the NG-RAN set-ups SLRB(s) and performs PC5-SDAP
configuration per destination for the UE. After that, the NG-RAN provides PC5-SDAP
configuration and SLRB setup information to the UE as Proposal 1.
Proposal 3: It is proposed that the NG-RAN set-ups SLRB(s) and performs PC5-SDAP
configuration per destination for the UE, based on the PC5 QoS profile received from
the UE.
When providing a UE with PC5-SDAP configuration and SLRB setup information, NG-
RAN may use or broadcast a dedicated signal (e.g., RRCReconfiguration message, etc.).
For any PC5 QoS Flow, the UE may provide updated PC5 QoS profile to the NG-RAN to
modify the PC5 QoS Flow. This may be construed as intending to modify QoS of the
corresponding PC5 QoS Flow. As a result, the NG-RAN may update the PC5-SDAP
configuration and SLRB setup, and provide the updated configuration information to the
UE.
The UE can request the SLRB release to the NG-RAN when the UE decides that any SLRB
is not needed any more, e.g. due to the following cases:
For broadcast, when the UE determines the SLRB is not needed anymore, e.g. based
on information from the V2X application layer that the related service was stopped or
completed resulting in removal of the corresponding PC5 QoS Flow(s) and PFI(s),
when an implementation dependent inactivity timer for the SLRB expired.

TABLE 29
For groupcast, when the UE determines the SLRB is not needed anymore, e.g. based
on information from the V2X application layer that the related group communication
was over or stopped resulting in removal of the corresponding PC5 QoS Flow(s) and
PFI(s), when an implementation dependent inactivity timer for the SLRB expired.
For unicast, when the UE determines the SLRB is not needed anymore, e.g. when the
PC5 unicast link was released, when the related PC5 QoS Flow(s) and PFI(s) were
removed from the PC5 unicast link.
As a result, the NG-RAN may release the PC5-SDAP entity and SLRB(s), and provide the
release configuration information to the UE.
For any PC5 QoS Flow, the UE may ask the NG-RAN to remove the PC5 QoS Flow. As a
result, the NG-RAN may update the PC5-SDAP configuration and SLRB setup, and provide
the updated configuration information to the UE. Or the NG-RAN may release the PC5-SDAP
entity and SLRB(s), and provide the release configuration information to the UE.
Alternatively, a UE may make a request for a release of a specific PC5-SDAP entity to NG-
RAN. As a result, the NG-RAN may release the PC5-SDAP entity and SLRB(s), and provide
the release configuration information to the UE.
When the UE makes a request for PC5 QoS Flow deletion to the NG-RAN, it may provide
related PFI information and destination information.
When the UE makes a request for a release of PC5-SDAP entity and a request for a release of
SLRB to the NG-RAN, it may provide related destination information.
The NG-RAN may not receive PC5 QoS profile information from the UE in direct. Instead,
such information may be configured in the NG-RAN or received from a core network (e.g.,
PCF, AMF, etc.). In the latter case, the core network may receive it from the UE or another
entity (e.g., UDR, UDM, etc.), or it may be configured in the corresponding entity already.
The <5> may apply to a UE autonomous resources selection mode as well as to a network
scheduled operation mode. In case of applying to the UE autonomous resources selection
mode, it may apply to a case that a UE is in connected mode only or to all cases.
In the above description, when the NG-RAN performs PC5-SDAP configuration and SLRB
setup for the UE, it may receive PQI information authorized or allowed for the corresponding
UE from the core network (e.g., PCF, AMF, etc.) and additionally receive allowed
MFBR/GFBR value information (if a PQI is provided for GBR PC5 QoS Flow), thereby
performing the PC5-SDAP configuration and SLRB setup based on the received informations.
For example, when PQI = 83 is not allowed for the UE based on the information received from
the core network, if the UE includes PQI = 83 in the PC5 QoS profile, an operation of not
configuring SLRB for this and an operation of rejecting it to the UE may be performed.

Examples of Communication Systems Applicable to the Present Disclosure

The various descriptions, functions, procedures, proposals, methods, and/or operational flowcharts of the present disclosure described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

FIG. 13 illustrates a communication system 1 applied to the present disclosure.

Referring to FIG. 13, a communication system 1 applied to the present disclosure includes wireless devices, BSs, and a network. Herein, the wireless devices represent devices performing communication using RAT (e.g., 5G NR or LTE) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of things (IoT) device 100f, and an artificial intelligence (AI) device/server 400. For example, the vehicles may include a vehicle having a wireless communication function, an autonomous driving vehicle, and a vehicle capable of performing communication between vehicles. Herein, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a B S/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. V2V/V2X communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as UL/DL communication 150a, sidelink communication 150b (or, D2D communication), or inter BS communication (e.g. relay, integrated access backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

Examples of Wireless Devices Applicable to the Present Disclosure

FIG. 14 illustrates wireless devices applicable to the present disclosure.

Referring to FIG. 14, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 13.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more service data unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

Examples of Signal Process Circuit Applicable to the Present Disclosure

FIG. 15 illustrates a signal process circuit for a transmission signal.

Referring to FIG. 15, a signal processing circuit 1000 may include scramblers 1010, modulators 1020, a layer mapper 1030, a precoder 1040, resource mappers 1050, and signal generators 1060. An operation/function of FIG. 15 may be performed, without being limited to, the processors 102 and 202 and/or the transceivers 106 and 206 of FIG. 14. Hardware elements of FIG. 15 may be implemented by the processors 102 and 202 and/or the transceivers 106 and 206 of FIG. 14. For example, blocks 1010 to 1060 may be implemented by the processors 102 and 202 of FIG. 14. Alternatively, the blocks 1010 to 1050 may be implemented by the processors 102 and 202 of FIG. 14 and the block 1060 may be implemented by the transceivers 106 and 206 of FIG. 14.

Codewords may be converted into radio signals via the signal processing circuit 1000 of FIG. 15. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

Specifically, the codewords may be converted into scrambled bit sequences by the scramblers 1010. Scramble sequences used for scrambling may be generated based on an initialization value, and the initialization value may include ID information of a wireless device. The scrambled bit sequences may be modulated to modulation symbol sequences by the modulators 1020. A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper 1030. Modulation symbols of each transport layer may be mapped (precoded) to corresponding antenna port(s) by the precoder 1040. Outputs z of the precoder 1040 may be obtained by multiplying outputs y of the layer mapper 1030 by an N*M precoding matrix W. Herein, N is the number of antenna ports and M is the number of transport layers. The precoder 1040 may perform precoding after performing transform precoding (e.g., DFT) for complex modulation symbols. Alternatively, the precoder 1040 may perform precoding without performing transform precoding.

The resource mappers 1050 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 1060 may generate radio signals from the mapped modulation symbols and the generated radio signals may be transmitted to other devices through each antenna. For this purpose, the signal generators 1060 may include IFFT modules, CP inserters, digital-to-analog converters (DACs), and frequency up-converters.

Signal processing procedures for a signal received in the wireless device may be configured in a reverse manner of the signal processing procedures 1010 to 1060 of FIG. 15. For example, the wireless devices (e.g., 100 and 200 of FIG. 14) may receive radio signals from the exterior through the antenna ports/transceivers. The received radio signals may be converted into baseband signals through signal restorers. To this end, the signal restorers may include frequency DL converters, analog-to-digital converters (ADCs), CP remover, and FFT modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

Examples of Application of Wireless Device Applicable to the Present Disclosure

FIG. 16 illustrates another example of a wireless device applied to the present disclosure. The wireless device may be implemented in various forms according to a use-case/service (refer to FIG. 13).

Referring to FIG. 16, wireless devices 100 and 200 may correspond to the wireless devices 100 and 200 of FIG. 14 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 14. For example, the transceiver(s) 114 may include the one or more transceivers 106 and 206 and/or the one or more antennas 108 and 208 of FIG. 14. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 13), the vehicles (100b-1 and 100b-2 of FIG. 13), the XR device (100c of FIG. 13), the hand-held device (100d of FIG. 13), the home appliance (100e of FIG. 13), the IoT device (100f of FIG. 13), a digital broadcast terminal, a hologram device, a public safety device, an MTC device, a medicine device, a FinTech device (or a finance device), a security device, a climate/environment device, the AI server/device (400 of FIG. 13), the BSs (200 of FIG. 13), a network node, etc. The wireless device may be used in a mobile or fixed place according to a use-example/service.

In FIG. 16, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an electronic control unit (ECU), a graphical processing unit, and a memory control processor. As another example, the memory 130 may be configured by a RAM, a DRAM, a ROM, a flash memory, a volatile memory, a non-volatile memory, and/or a combination thereof.

Hereinafter, an example of implementing FIG. 16 will be described in detail with reference to the drawings.

Examples of a hand-held device applicable to the present disclosure

FIG. 17 illustrates a hand-held device applied to the present disclosure. The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a mobile subscriber station (MSS), a subscriber station (SS), an advanced mobile station (AMS), or a wireless terminal (WT).

Referring to FIG. 17, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c correspond to the blocks 110 to 130/140 of FIG. 16, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an application processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

Examples of a Vehicle or an Autonomous Driving Vehicle Applicable to the Present Disclosure

FIG. 18 illustrates a vehicle or an autonomous driving vehicle applied to the present disclosure. The vehicle or autonomous driving vehicle may be implemented by a mobile robot, a car, a train, a manned/unmanned aerial vehicle (AV), a ship, etc.

Referring to FIG. 18, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 16, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an ECU. The driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an inertial measurement unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is configured, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

Examples of a Vehicle and AR/VR Applicable to the Present Disclosure

FIG. 19 illustrates a vehicle applied to the present disclosure. The vehicle may be implemented as a transport means, an aerial vehicle, a ship, etc.

Referring to FIG. 19, a vehicle 100 may include a communication unit 110, a control unit 120, a memory unit 130, an I/O unit 140a, and a positioning unit 140b. Herein, the blocks 110 to 130/140a and 140b correspond to blocks 110 to 130/140 of FIG. 16.

The communication unit 110 may transmit and receive signals (e.g., data and control signals) to and from external devices such as other vehicles or BSs. The control unit 120 may perform various operations by controlling constituent elements of the vehicle 100. The memory unit 130 may store data/parameters/programs/code/commands for supporting various functions of the vehicle 100. The I/O unit 140a may output an AR/VR object based on information within the memory unit 130. The I/O unit 140a may include an HUD. The positioning unit 140b may acquire information about the position of the vehicle 100. The position information may include information about an absolute position of the vehicle 100, information about the position of the vehicle 100 within a traveling lane, acceleration information, and information about the position of the vehicle 100 from a neighboring vehicle. The positioning unit 140b may include a GPS and various sensors.

As an example, the communication unit 110 of the vehicle 100 may receive map information and traffic information from an external server and store the received information in the memory unit 130. The positioning unit 140b may obtain the vehicle position information through the GPS and various sensors and store the obtained information in the memory unit 130. The control unit 120 may generate a virtual object based on the map information, traffic information, and vehicle position information and the I/O unit 140a may display the generated virtual object in a window in the vehicle (1410 and 1420). The control unit 120 may determine whether the vehicle 100 normally drives within a traveling lane, based on the vehicle position information. If the vehicle 100 abnormally exits from the traveling lane, the control unit 120 may display a warning on the window in the vehicle through the I/O unit 140a. In addition, the control unit 120 may broadcast a warning message regarding driving abnormity to neighboring vehicles through the communication unit 110. According to situation, the control unit 120 may transmit the vehicle position information and the information about driving/vehicle abnormality to related organizations.

Examples of an XR Device Applicable to the Present Disclosure

FIG. 20 illustrates an XR device applied to the present disclosure. The XR device may be implemented by an HMD, an HUD mounted in a vehicle, a television, a smartphone, a computer, a wearable device, a home appliance, a digital signage, a vehicle, a robot, etc.

Referring to FIG. 20, an XR device 100a may include a communication unit 110, a control unit 120, a memory unit 130, an I/O unit 140a, a sensor unit 140b, and a power supply unit 140c. Herein, the blocks 110 to 130/140a to 140c correspond to the blocks 110 to 130/140 of FIG. 16, respectively.

The communication unit 110 may transmit and receive signals (e.g., media data and control signals) to and from external devices such as other wireless devices, hand-held devices, or media servers. The media data may include video, images, and sound. The control unit 120 may perform various operations by controlling constituent elements of the XR device 100a. For example, the control unit 120 may be configured to control and/or perform procedures such as video/image acquisition, (video/image) encoding, and metadata generation and processing. The memory unit 130 may store data/parameters/programs/code/commands needed to drive the XR device 100a/generate XR object. The I/O unit 140a may obtain control information and data from the exterior and output the generated XR object. The I/O unit 140a may include a camera, a microphone, a user input unit, a display unit, a speaker, and/or a haptic module. The sensor unit 140b may obtain an XR device state, surrounding environment information, user information, etc. The sensor unit 140b may include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, a light sensor, a microphone and/or a radar. The power supply unit 140c may supply power to the XR device 100a and include a wired/wireless charging circuit, a battery, etc.

For example, the memory unit 130 of the XR device 100a may include information (e.g., data) needed to generate the XR object (e.g., an AR/VR/MR object). The I/O unit 140a may receive a command for manipulating the XR device 100a from a user and the control unit 120 may drive the XR device 100a according to a driving command of a user. For example, when a user desires to watch a film or news through the XR device 100a, the control unit 120 transmits content request information to another device (e.g., a hand-held device 100b) or a media server through the communication unit 130. The communication unit 130 may download/stream content such as films or news from another device (e.g., the hand-held device 100b) or the media server to the memory unit 130. The control unit 120 may control and/or perform procedures such as video/image acquisition, (video/image) encoding, and metadata generation/processing with respect to the content and generate/output the XR object based on information about a surrounding space or a real object obtained through the I/O unit 140a/sensor unit 140b.

The XR device 100a may be wirelessly connected to the hand-held device 100b through the communication unit 110 and the operation of the XR device 100a may be controlled by the hand-held device 100b. For example, the hand-held device 100b may operate as a controller of the XR device 100a. To this end, the XR device 100a may obtain information about a 3D position of the hand-held device 100b and generate and output an XR object corresponding to the hand-held device 100b.

Examples of a Robot Applicable to the Present Disclosure

FIG. 21 illustrates a robot applied to the present disclosure. The robot may be categorized into an industrial robot, a medical robot, a household robot, a military robot, etc., according to a used purpose or field.

Referring to FIG. 21, a robot 100 may include a communication unit 110, a control unit 120, a memory unit 130, an I/O unit 140a, a sensor unit 140b, and a driving unit 140c. Herein, the blocks 110 to 130/140a to 140c correspond to the blocks 110 to 130/140 of FIG. 16, respectively.

The communication unit 110 may transmit and receive signals (e.g., driving information and control signals) to and from external devices such as other wireless devices, other robots, or control servers. The control unit 120 may perform various operations by controlling constituent elements of the robot 100. The memory unit 130 may store data/parameters/programs/code/commands for supporting various functions of the robot 100. The I/O unit 140a may obtain information from the exterior of the robot 100 and output information to the exterior of the robot 100. The I/O unit 140a may include a camera, a microphone, a user input unit, a display unit, a speaker, and/or a haptic module. The sensor unit 140b may obtain internal information of the robot 100, surrounding environment information, user information, etc. The sensor unit 140b may include a proximity sensor, an illumination sensor, an acceleration sensor, a magnetic sensor, a gyro sensor, an inertial sensor, an IR sensor, a fingerprint recognition sensor, an ultrasonic sensor, a light sensor, a microphone, a radar, etc. The driving unit 140c may perform various physical operations such as movement of robot joints. In addition, the driving unit 140c may cause the robot 100 to travel on the road or to fly. The driving unit 140c may include an actuator, a motor, a wheel, a brake, a propeller, etc.

Examples of an AI Device Applicable to the Present Disclosure

FIG. 22 illustrates an AI device applied to the present disclosure. The AI device may be implemented by a fixed device or a mobile device, such as a TV, a projector, a smartphone, a PC, a notebook, a digital broadcast terminal, a tablet PC, a wearable device, a Set Top Box (STB), a radio, a washing machine, a refrigerator, a digital signage, a robot, a vehicle, etc.

Referring to FIG. 22, an AI device 100 may include a communication unit 110, a control unit 120, a memory unit 130, an I/O unit 140a/140b, a learning processor unit 140c, and a sensor unit 140d. The blocks 110 to 130/140a to 140d correspond to blocks 110 to 130/140 of FIG. 16, respectively.

The communication unit 110 may transmit and receive wired/radio signals (e.g., sensor information, user input, learning models, or control signals) to and from external devices such as other AI devices (e.g., 100x, 200, or 400 of FIG. 13) or an AI server (e.g., 400 of FIG. 13) using wired/wireless communication technology. To this end, the communication unit 110 may transmit information within the memory unit 130 to an external device and transmit a signal received from the external device to the memory unit 130.

The control unit 120 may determine at least one feasible operation of the AI device 100, based on information which is determined or generated using a data analytics algorithm or a machine learning algorithm. The control unit 120 may perform an operation determined by controlling constituent elements of the AI device 100. For example, the control unit 120 may request, search, receive, or use data of the learning processor unit 140c or the memory unit 130 and control the constituent elements of the AI device 100 to perform a predicted operation or an operation determined to be preferred among at least one feasible operation. The control unit 120 may collect history information including the operation contents of the AI device 100 and operation feedback by a user and store the collected information in the memory unit 130 or the learning processor unit 140c or transmit the collected information to an external device such as an AI server (400 of FIG. 13). The collected history information may be used to update a learning model.

The memory unit 130 may store data for supporting various functions of the AI device 100. For example, the memory unit 130 may store data obtained from the input unit 140a, data obtained from the communication unit 110, output data of the learning processor unit 140c, and data obtained from the sensor unit 140. The memory unit 130 may store control information and/or software code needed to operate/drive the control unit 120.

The input unit 140a may acquire various types of data from the exterior of the AI device 100. For example, the input unit 140a may acquire learning data for model learning, and input data to which the learning model is to be applied. The input unit 140a may include a camera, a microphone, and/or a user input unit. The output unit 140b may generate output related to a visual, auditory, or tactile sense. The output unit 140b may include a display unit, a speaker, and/or a haptic module. The sensing unit 140 may obtain at least one of internal information of the AI device 100, surrounding environment information of the AI device 100, and user information, using various sensors. The sensor unit 140 may include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, a light sensor, a microphone, and/or a radar.

The learning processor unit 140c may learn a model consisting of artificial neural networks, using learning data. The learning processor unit 140c may perform AI processing together with the learning processor unit of the AI server (400 of FIG. 13). The learning processor unit 140c may process information received from an external device through the communication unit 110 and/or information stored in the memory unit 130. In addition, an output value of the learning processor unit 140c may be transmitted to the external device through the communication unit 110 and may be stored in the memory unit 130.

### INDUSTRIAL APPLICABILITY

The above-described embodiments of the present disclosure are applicable to various mobile communication systems.

What is claimed is:

1. A method of operating a first User Equipment (UE) in a wireless communication system, the method comprising:
deriving, by the first UE, a plurality of PC5 QoS (Quality of Service) parameters for a plurality of services, respectively; and
assigning, by the first UE, PFIs (PC5 QoS Flow Identifiers) to a plurality of the services based on a plurality of the PC5 QoS parameters, respectively,
wherein although the same PC5 QoS parameter is derived from two or more of a plurality of the services, different PFIs are assigned to the two or more services, respectively.

2. The method of claim 1, wherein a plurality of the services are related to one PC5 unicast link between the first UE and a second UE.

3. The method of claim 2, wherein the PFI, the PC5 QoS parameter related to the PFI and service information are delivered to the second UE via a PC5-S message.

4. The method of claim 2, wherein the first UE corresponds to a UE starting PC5 unicast link establishment or a UE initiating established PC5 unicast link modification.

5. The method of claim 1, wherein each of a plurality of the PC5 QoS parameters is derived by a V2X layer using PC5 QoS requirements provided by an application layer as an input.

6. The method of claim 1, wherein each of a plurality of the PC5 QoS parameters is related to a default value for the PC5 QoS parameter based on that PC5 QoS related information is not provided by an application layer.

7. The method of claim 1, wherein a plurality of the services are identified by Provider Service Identifier (PSID) or ITS Application Identifier (ITS-AID).

8. An apparatus in a wireless communication system, the apparatus comprising:
at least one processor; and
at least one computer memory operatively connected to the at least one processor and storing instructions enabling the at least one processor to perform operations when executed, the operations comprising:
deriving a plurality of PC5 QoS (Quality of Service) parameters for a plurality of services by the first UE, respectively; and
assigning PFIs (PC5 QoS Flow Identifiers) to a plurality of the services by the first UE based on a plurality of the PC5 QoS parameters, respectively,
wherein although the same PC5 QoS parameter is derived from two or more of a plurality of the services, different PFIs are assigned to the two or more services, respectively.

9. The apparatus of claim 8, wherein a plurality of the services are related to one PC5 unicast link between the first UE and a second UE.

10. The apparatus of claim 9, wherein the PFI, the PC5 QoS parameter related to the PFI and service information are delivered to the second UE via a PC5-S message.

11. The apparatus of claim 9, wherein the first UE corresponds to a UE starting PC5 unicast link establishment or a UE initiating established PC5 unicast link modification.

12. The apparatus of claim 8, wherein each of a plurality of the PC5 QoS parameters is derived by a V2X layer using PC5 QoS requirements provided by an application layer as an input.

13. The apparatus of claim 8, wherein each of a plurality of the PC5 QoS parameters is related to a default value for the PC5 QoS parameter based on that PC5 QoS related information is not provided by an application layer.

14. The apparatus of claim 8, wherein a plurality of the services are identified by Provider Service Identifier (PSID) or ITS Application Identifier (ITS-AID).
